(19) United States
(12) Patent Application Publication
(10) Pub. No.: US 2025/0167557 A1
(43) Pub. Date: May 22, 2025

(54) FLEXIBLE DC CONVERTER FEATURING MULTI-PORT DC POWER FLOW CONTROL AND CONTROL METHOD THEREOF

(71) Applicant: SHANGHAI JIAO TONG UNIVERSITY, Shanghai (CN)

(72) Inventors: Jianwen ZHANG, Shanghai (CN); Jianqiao ZHOU, Shanghai (CN); Gang SHI, Shanghai (CN); Xu CAI, Shanghai (CN); Yuwen LIU, Shanghai (CN); Liqian SU, Shanghai (CN); Kejing LIANG, Shanghai (CN)

(73) Assignee: SHANGHAI JIAO TONG UNIVERSITY, Shanghai (CN)

(21) Appl. No.: 19/027,394

(22) Filed: Jan. 17, 2025

Related U.S. Application Data
(63) Continuation of application No. PCT/CN2023/087952, filed on Apr. 13, 2023.

(30) Foreign Application Priority Data
Jul. 19, 2022 (CN) 202210850282.9

(51) Int. Cl. H02J 3/36; H02J 3/00; H02J 3/06; H02J 3/14; H02J 3/24

(52) U.S. Cl. CPC H02J 3/36; H02J 3/00125; H02J 3/06; H02J 3/144; H02J 3/241; H02J 2203/20; H02J 2310/60

(57) ABSTRACT

A flexible DC converter comprises a MMC and a DCPFC embedded within the flexible DC converter. The flexible DC converter features modularity and a flexible number of ports, enabling bidirectional control of DC power flow of two or more lines, addressing the issue of insufficient degrees of freedom in DC power flow control in meshed DC systems. The DCPFC is directly embedded in the flexible DC converter, allowing for energy balance without the need for external power sources and high-voltage isolation devices, with a wide range of power flow regulation. The control method can manage both internal and external energy balance of the device. Additionally, a main circuit parameter designing method can serve as a basis for selecting circuit components for the device. A fault protection strategy and an active fault current suppression method can enhance the reliability of the device under complex extreme conditions.

### CROSS-REFERENCE TO RELATED APPLICATIONS

This application is a continuation of International Patent Application No. PCT/CN2023/087952 with a filing date of Apr. 13, 2024, designating the United States, now pending, and further claims priority to Chinese Patent Application No. 202210850282.9 with a filing date of Jul. 19, 2022. The content of the aforementioned applications, including any intervening amendments thereto, is incorporated herein by reference.

### BACKGROUND OF THE INVENTION

### 1. Technical Field

The disclosure relates to the technical field of Voltage Source Converter based High Voltage Direct Current (VSC-HVDC) transmission and distribution and power electronics, in particular to a Modular Multilevel Converter (MMC) featuring multi-port direct current (DC) power flow control for a high-voltage DC power transmission network and a control method thereof.

### 2. Description of Related Art

VSC-HVDC technology features independent controllability of active and reactive power, no need for reactive power compensation, the ability to supply power to passive networks, and consistent voltage polarity during power flow reversal. This enhances the flexibility of system operation control. The VSC-HVDC transmission and distribution system has evolved from the initial “point-to-point” structure with a single sending end and a single receiving end, to a multi-terminal flexible DC system structure with multiple power supplies and multiple power reception points. In the future, it is expected to develop into more complex ring-mesh topologies. The mesh flexible DC system can further enhance the flexibility of operation control, system redundancy, and power supply reliability, facilitating the integration of various types of wide-area power sources. This allows for efficient transmission and optimal distribution of electrical energy over large areas, meeting the current demand for large-scale development of new energy with multi-terminal grid connection, multiple power reception points, and wide-area interconnection. It can effectively alleviate voltage stability issues caused by new energy power fluctuations and frequency stability issues in large interconnected AC grids.

In DC systems with a mesh structure, multiple loops exist between some controllable nodes, which enhances the flexibility of configuration and control, as well as power supply reliability. However, when the number of transmission lines is greater than or equal to the number of controllable nodes, it becomes impossible to fully control the DC line power flow solely by using converter control. This can lead to issues such as transmission section congestion, line overloading, and excessive line losses.

### BRIEF SUMMARY OF THE INVENTION

This section aims to outline certain aspects of the embodiments of the present disclosure and to briefly introduce some preferred embodiments. Simplifications or omissions may be made in this section and the abstract and title of the application to avoid obscuring the purpose of these elements. Such simplifications or omissions should not be interpreted as limiting the scope of the present disclosure.

In light of the aforementioned existing issues, the present disclosure is proposed.

Therefore, the disclosure provides a flexible DC converter featuring multi-port DC power flow control and a control method thereof, which can solve issues such as transmission section congestion, line overloading, and excessive line losses.

To solve the above technical problems, the disclosure provides the following technical scheme. A flexible DC converter featuring multi-port DC power flow control comprises:
a MMC; and
a DC power flow controller (DCPFC) embedded within the MMC.

As a preferable scheme of the flexible DC converter featuring multi-port DC power flow control provided by the disclosure, the DCPFC comprises two or more DC power flow control units, the number of the DC power flow control units is equal to the number of ports of the DCPFC, and each DC power flow control unit is capable of adjusting the DC power flow on a connected DC line.

As a preferable scheme of the flexible DC converter featuring multi-port DC power flow control provided by the disclosure, the DC power flow control unit consists of a three-phase star-connected submodule chain and an arm inductor, and a three-phase neutral point resulting from the connection of the submodule chain and the inductor serves as a DC power flow regulation port.

As a preferable scheme of the flexible DC converter featuring multi-port DC power flow control provided by the disclosure, the MMC is a medium- or high-voltage, three-phase voltage source converter with a modular multilevel structure, capable of AC-DC power conversion, facilitating the interconnection of medium- and high-voltage AC power grids with DC systems.

As a preferable scheme of the flexible DC converter featuring multi-port DC power flow control provided by the disclosure, the embedded DCPFC is symmetrically installed on both upper and lower arms of the MMC, or installed on either the upper arm or the lower arm of the MMC.

As a preferable scheme of the flexible DC converter featuring multi-port DC power flow control provided by the disclosure, the submodule chain is a unipolar submodule chain, a bipolar submodule chain, or a hybrid submodule chain comprising both unipolar and bipolar submodules.

The disclosure also provides the following technical scheme. A control method of the embedded multi-port DCPFC comprises DC power flow control loops on multiple lines, energy balance control loops between the MMC and the DCPFC, and internal energy balance control loops within the DCPFC, wherein

when the embedded multi-port DCPFC connects two or more DC lines, the sum of power on all output lines equals the total power of the MMC; if the embedded multi-port DCPFC connects a total of N DC output lines, it is possible to perform active control on the power flow of N−1 lines, while the DC power flow on the remaining line equals the total power flow minus the sum of the power flow on the other lines.

As a preferable scheme of the control method of the embedded multi-port DCPFC provided by the disclosure, for the DC power flow control loops on multiple lines,
a line power flow control loop calculates a difference between voltage reference values of other lines and a reference circuit voltage to determine DC components of voltages of each DC power flow control unit, and the mathematical equation is as follows:

$$\{ \begin{matrix}{U}_{p1a , d c} = {U}_{o 1} - {U}_{d} \\ ⋮ \\ {U}_{pka , d c} = {U}_{ok} - {U}_{d} \\ ⋮ \\ {U}_{pNa , d c} = {U}_{o N} - {U}_{d}\end{matrix}$$

where U_{d} is a rated voltage of a DC system, which is also equal to a reference line voltage; Up1a, Uₚₖₐ and U_{pNa} are the DC components of the voltages of the DC power flow control units connected to the first line, the kth line, and the Nth line respectively; and Uₒₗ, Uₒₖ and U_{oN} are DC voltage reference values of the first line, the kth line, and the Nth line respectively.

As a preferable scheme of the control method of the embedded multi-port DCPFC provided by the disclosure, for the energy balance control loops between the MMC and the DCPFC,
by superimposing energy balancing control voltages on arms of the DC flow power control units and arms of the modular multilevel converter, AC coupled energy is formed to compensate for accumulated DC energy, and the mathematical equation for the overall input and output energy of the DCPFC is as follows:

$$\{ \begin{matrix}{P}_{DCPFC \_ out} = {\sum }_{i = 1}^{N} ( {U}_{pia , d c} - \frac{1}{N} {\sum }_{l = 1}^{N} {U}_{pla , d c} ) {I}_{o i} \\ {P}_{DCPFC \_ in} = {\sum }_{j = a , b , c} {i}_{jp , a c} ( \frac{1}{N} {\sum }_{i = 1}^{N} {U}_{pij , a c} ) + ( \frac{1}{N} {\sum }_{i = 1}^{N} {U}_{pia , d c} ) {I}_{d}\end{matrix}$$

where P_{DCPFC_out} is the total output energy of the multi-port DCPFC, P_{DCPFC_in} is the total input energy of the multi-port DCPFC, U_{pia,dc} and U_{pia,ac} are DC and AC components of a voltage of the DC power flow control unit connected to the i^{th} line respectively, Iₒᵢ is a DC current of the i^{th} line, Id is the sum of DC currents of all lines, and i_{jp,ac} is an AC component of an upper arm current in phase j of the MMC.

As a preferable scheme of the control method of the embedded multi-port DCPFC provided by the disclosure, for the internal energy balance control loops within the DCPFC,
the mathematical equation for the energy relationship within the DCPFC is as follows:

$$\frac{Δ {p}_{1}}{3} + \underline{Δ {p}_{c 1 a}} = … = \frac{Δ {p}_{k}}{3} + \underline{Δ {p}_{cka}} = … = \frac{Δ {p}_{N}}{3} + \underline{Δ {p}_{cNa}} , {\sum }_{i = 1}^{N} \underline{Δ {p}_{c i a}} = 0$$

where Δp1, Δpₖ and Δp_{N} are DC energy of the first, k^{th} and N^{th} DC power flow control units respectively, and Δp_{c1a}, Δp_{cka} and Δp_{cNa} are AC coupled energy of the first, k^{th} and N^{th} DC power flow control units respectively.

The disclosure also provides the following technical scheme. A main circuit parameter designing method for the embedded multi-port DCPFC comprises the design of the number of submodules of the DC power flow control unit and the MMC, the design of the capacitance of submodules of the DC power flow control unit and the MMC, the design of the arm inductance of the DCPFC, and the design of power devices of submodules of the DC power flow control unit and the MMC.

As a preferable scheme of the main circuit parameter designing method for the embedded multi-port DCPFC provided by the disclosure,
the DCPFC is installed asymmetrically, embedded at an end of the upper arm of the MMC; and
the DCPFC uses bipolar full-bridge submodules, and the MMC employs unipolar half-bridge submodules.

As a preferable scheme of the main circuit parameter designing method for the embedded multi-port DCPFC provided by the disclosure,
for the design of the number of submodules of the DC power flow control unit and the MMC,
the mathematical equation for selecting the number of submodules of the DCPFC is as follows:

$${N}_{PFC} \geq \frac{ε {U}_{d}}{2 {U}_{CPFC}} + \frac{1}{{U}_{CPFC}} \sqrt{{( 2 ε E \frac{Δ {P}_{1 , 2} cos ( φ - δ )}{P} )}^{2} + {( \frac{ω {L}_{PFC}}{6 E} \cdot \frac{P}{Δ {P}_{1 , 2} cos ( φ - δ )} )}^{2}} \geq \frac{ε {U}_{d}}{2 {U}_{CPFC}}$$

where N_{PFC} is the number of submodules in a submodule chain in the DCPFC, U_{CPFC} is a rated voltage of the submodules in the DCPFC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
the mathematical equation for selecting the number of submodules of the MMC is as follows:

$$\{ \begin{matrix}\begin{matrix}{N}_{MMC \_ p} \geq [ \frac{1}{2} - \frac{ε Δ {P}_{1 , 2}}{4 P} ] \frac{{U}_{d}}{{U}_{C}} + \\ \frac{1}{{U}_{C}} \sqrt{{E}^{2} + {[ ε \frac{Δ {P}_{1 , 2} E cos ( φ - δ )}{P} ]}^{2} + {( \frac{ω {L}_{PFC} P}{12 E cos ( φ - δ )} )}^{2}}\end{matrix} \\ {N}_{MMC \_ n} \geq [ \frac{1}{2} + \frac{ε Δ {P}_{1 , 2}}{4 P} ] \frac{{U}_{d}}{{U}_{C}} + \frac{1}{{U}_{C}} \sqrt{{E}^{2} + {( \frac{ω {L}_{PFC} P}{12 E cos ( φ - δ )} )}^{2}}\end{matrix}$$

where N_{MMC,p} and N_{MMC,n} are the number of submodules of the upper arm and lower arm of the MMC respectively, U_{C} is a rated voltage of the submodules of the MMC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

As a preferable scheme of the main circuit parameter designing method for the embedded multi-port DCPFC provided by the disclosure,
for the design of the capacitance of submodules of the DC power flow control unit and the MMC,
the mathematical equation for selecting the capacitance value of submodules of the DCPFC is as follows:

$$\{ \begin{matrix}{C}_{PFC} \geq \frac{1}{{r}_{1}} \cdot \frac{1}{{N}_{PFC} {U}_{CPFC}} \sqrt{{ε}^{2} {[ \frac{1.6}{11 ω cos ( φ − δ )} + \frac{2 P cos ( φ − δ )}{11 ω} ]}^{2} + {[ \frac{{L}_{PFC} {P}^{2}}{16 {E}^{2}} ]}^{2}} \\ {C}_{PFC} \geq \frac{1}{{r}_{2}} \cdot \frac{1}{{N}_{PFC} {U}_{CPFC}} \sqrt{{[ \frac{{L}_{PFC} {P}^{2} [ 2 cos ( φ − δ ) − 1.8 ]}{259 {E}^{2} cos ( φ − δ )} ]}^{2} + {ε}^{2} {[ \frac{[ 2 cos ( φ − δ ) − 1.8 ] P}{86 ω} ]}^{2}}\end{matrix}$$

where CPFC is the capacitance of the submodules of the DCPFC, NPFC is the number of submodules in a submodule chain in the DCPFC, UCPFC is a rated voltage of the submodules in the DCPFC, r₁ and r₂ are fundamental frequency and double frequency fluctuation rates of a submodule capacitor voltage respectively, ε is a ratio of a maximum regulating voltage of the DCPFC to a rated voltage of a DC grid, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
the mathematical equation for selecting the capacitance value of modular multilevel submodules is as follows:

$$\{ \begin{matrix}{C}_{0} \geq \frac{1}{{ε}_{1}} \cdot \vert \frac{3 P}{10 ω {N}_{MMC}^{2} {U}_{C}^{2} cos ( φ - δ )} \vert \\ {C}_{0} \geq \frac{1}{{ε}_{2}} \cdot \vert \frac{P}{12 ω {N}_{MMC}^{2} {U}_{C}^{2} cos ( φ - δ )} \vert\end{matrix}$$

where C₀ is the capacitance of the submodules of the MMC, N_{MMC} is the number of submodules in one arm of the MMC, U_{C} is a rated voltage of submodule capacitors of the MMC, ε₁ and ε₂ are fundamental frequency and double frequency fluctuation rates of a submodule capacitor voltage of the MMC respectively, P is the total power of the MMC, φ is a phase angle of an AC current of the MMC, and δ is a phase angle difference between a fundamental AC component of an arm voltage of the MMC and a grid voltage.

As a preferable scheme of the main circuit parameter designing method for the embedded multi-port DCPFC provided by the disclosure, for the design of the arm inductance of the DCPFC,
the mathematical equation for selecting the arm inductance of the DCPFC
is as follows:

$$\{ \begin{matrix}AC negative sequence current constraint : \\ {L}_{PFC} \geq \frac{2}{{ω}_{0}} sin ( 2 arc sin ( \frac{1.5 \%}{η} ) ) - 4 {L}_{T} - 2 {L}_{0} \\ Internal energy balance constraint for DC \\ power flow control device : \\ {L}_{P F C} \leq \frac{3 {N}_{PFC} {U}_{CPFC}}{4 {I}_{d} {ω}_{0}} \\ Short - circuit fault current suppression limit : \\ {L}_{PFC} \geq \frac{( 2 + ε ) {U}_{d}}{λ} - 12 {L}_{dc} - 4 {L}_{0} \\ Resonant frequency limit for phase unit : \\ {ω}_{res} = \sqrt{\frac{{N}_{MMC}^{2} + {N}_{PFC}^{2}}{( 4 {L}_{0} + {L}_{PFC} ) ( {N}_{MMC} + {N}_{PFC} ) {C}_{0}}} \approx {ω}_{0}\end{matrix}$$

where L_{PFC} is the arm inductance of the DCPFC, ω₀ is angular frequency at the fundamental frequency, ωᵣₑₛ is resonant angular frequency of the series resonance formed between the submodule chain and arm inductance within a phase unit of an integrated system of the DCPFC and the MMC, L_{T} is an inductance value of a connected transformer, L₀ is an arm inductance value of the MMC, L_{dc} is an inductance value of a smoothing reactor of a DC system, N_{PFC} is the number of submodules in a submodule chain of the DCPFC, U_{CPFC} is a rated voltage of submodules in the DCPFC, U_{d} is a rated voltage of a DC grid, I_{d} is a rated current of the DC grid, ε is a ratio of a maximum regulating voltage of the DCPFC to the rated voltage of the DC grid, λ is an upper limit of a transient current change rate under short-circuit faults, η is a per-unit value of a negative sequence current amplitude, C₀ is the capacitance of submodules of the MMC, and N_{MMC} is the number of submodules in one arm of the MMC.

As a preferable scheme of the main circuit parameter designing method for the embedded multi-port DCPFC provided by the disclosure,
for the design of power devices of submodules of the DC power flow control unit and the MMC,
the mathematical equation for calculating the voltage and current stresses of the power devices of the DC power flow control unit is as follows:

$$\{ \text{} \begin{matrix}{A}_{PFC \_ U} = \frac{ε {U}_{d}}{4 {N}_{PFC}} + \frac{1}{2 {U}_{d} {N}_{PFC}} \sqrt{{( \frac{Δ {P}_{1 , 2} E cos ( φ − δ )}{P} )}^{2} + {( \frac{ω {L}_{PFC} P}{3} )}^{2}} \\ {A}_{PFC \_ Ures} = \frac{ε {U}_{d}}{4 {N}_{PFC}} + \frac{1}{4 {U}_{d} {N}_{PFC}} \sqrt{2 {( \frac{Δ {P}_{1 , 2} E cos ( φ − δ )}{P} )}^{2} + 2 {( \frac{ω {L}_{PFC} P}{3} )}^{2}}\end{matrix}$$

$$\{ \begin{matrix}{A}_{PFC \_ I} = \frac{max \{ {P}_{1} , {P}_{2} \}}{3 {U}_{d}} + P \sqrt{{( \frac{1}{6 E cos ( φ − δ )} )}^{2} + {( \frac{1}{3 {U}_{d}} )}^{2}} \\ {A}_{PFC \_ Ires} = \frac{max \{ {P}_{1} , {P}_{2} \}}{3 {U}_{d}} + \frac{P \sqrt{2 {( \frac{1}{6 E cos ( φ − δ )} )}^{2} + 2 {( \frac{1}{3 {U}_{d}} )}^{2}}}{2}\end{matrix}$$

where A_{PFC_U} and A_{PFC_Ures} are peak and effective values of a maximum voltage withstood by a single power electronic device in an arm submodule of the DCPFC respectively, A_{PFC_I} and A_{PFC_Ires} are peak and effective values of a maximum current withstood by a single power electronic device in the arm submodule of the DCPFC respectively, P₁ and P₂ are the DC power flow of two DC lines, ΔP_{1,2} is a maximum difference between the DC power flow of the two DC lines, ε is a ratio of a maximum regulating voltage of the DCPFC to a rated voltage of a DC grid, U_{d} is the rated voltage of the DC grid, N_{PFC} is the number of submodules in a submodule chain of the DCPFC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
the mathematical equation for calculating the voltage and current stresses of the power devices of the MMC is as follows:

$$\{ \begin{matrix}{A}_{MMC \_ U} = \frac{1}{2 {N}_{MMC}} \{ \begin{matrix}[ \frac{1}{2} + \frac{Δ {P}_{1 , 2}}{2 {EU}_{d} cos ( φ − δ )} ] {U}_{d} + \\ \sqrt{{E}^{2} + {( \frac{Δ {P}_{1 , 2} E cos ( φ − δ )}{P {U}_{d}} )}^{2} + {( \frac{ω {L}_{PFC} P}{12 E cos ( φ − δ )} )}^{2}}\end{matrix} \} \\ {A}_{MMC \_ Ures} = \frac{1}{2 {N}_{MMC}} \{ \frac{\begin{matrix}[ \frac{1}{2} + \frac{Δ {P}_{1 , 2}}{2 {EU}_{d} cos ( φ − δ )} ] {U}_{d} + \\ \sqrt{2 {E}^{2} + 2 {( \frac{Δ {P}_{1 , 2} E cos ( φ − δ )}{P {U}_{d}} )}^{2} + 2 {( \frac{ω {L}_{PFC} P}{12 E cos ( φ − δ )} )}^{2}}\end{matrix}}{2} \}\end{matrix}$$

$$\{ \begin{matrix}{A}_{MMC \_ I} = \frac{P}{3 {U}_{d}} + \frac{P}{3 E cos ( φ - δ )} \\ {A}_{MMC \_ Ires} = \frac{P}{3 {U}_{d}} + \frac{\sqrt{2} P}{6 E cos ( φ - δ )}\end{matrix}$$

where A_{MMC_U} and A_{MMC_Ures} are peak and effective values of a maximum voltage withstood by a single power electronic device in an arm submodule of the MMC respectively, A_{MMC_I} and A_{MMC_Ires} are peak and effective values of a maximum current withstood by a single power electronic device in the arm submodule of the MMC respectively, ΔP_{1,2} is a maximum difference between the DC power flow of two DC lines, U_{d} is a rated voltage of a DC grid, N_{MMC} is the number of submodules in one arm of the MMC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

The disclosure also provides the following technical scheme. A protection method for the embedded multi-port DCPFC under DC short-circuit faults comprises the protection of the DCPFC under DC short-circuit faults, and the active restriction of fault currents under DC short-circuit faults.

As a preferable scheme of the protection method for the embedded multi-port DCPFC under DC short-circuit faults provided by the disclosure,
the protection of the DCPFC under DC short-circuit faults comprises:
controlling the submodules within the DCPFC to operate in a specific switching state, or installing a protection device on the submodules within the DCPFC;
the specific switching state of the submodule refers to the condition where a submodule capacitor is bypassed and currents flow solely through a switching device, and the protection device consists of a load shedding circuit or a thyristor bypass switch; and
the switching device of the submodule withstands fault currents, and by operating the submodule in the specific switching state, the fault currents are prevented from flowing into the submodule capacitor, thus achieving fault protection.

As a preferable scheme of the protection method for the embedded multi-port DCPFC under DC short-circuit faults provided by the disclosure,
the protection device is a load shedding circuit connected in parallel with the submodule capacitor,
the load shedding circuit is formed by a combination of diodes, resistors, and switching devices in series and parallel, which dissipates the energy of the fault currents to prevent overvoltage across the submodule capacitor, thereby achieving fault protection.

As a preferable scheme of the protection method for the embedded multi-port DCPFC under DC short-circuit faults provided by the disclosure,
the protection device is a distributed or centralized thyristor bypass switch, the thyristor bypass switch consists of anti-parallel thyristors, a resistor-capacitor circuit, and static resistors connected in parallel, the distributed thyristor bypass switches are installed within each submodule, and the centralized thyristor bypass switches are connected in parallel with the submodule chains; and the submodules are bypassed through the fast action of the bidirectional thyristors, preventing the fault currents from flowing through the submodules, thus achieving fault protection.

As a preferable scheme of the protection method for the embedded multi-port DCPFC under DC short-circuit faults provided by the disclosure,
the active restriction of fault currents under DC short-circuit faults comprises:
controlling the submodules within the DCPFC to operate in a specific switching state, or installing a protection device on the submodules within the DCPFC;
the specific switching state of the submodule refers to the condition where the submodule is locked or positively engaged, the protection device consists of a load shedding circuit and a fault current limiter, the load shedding circuit is formed by a combination of diodes, resistors, and switching devices arranged in series and parallel, and the fault current limiter is formed by a combination of resistors, inductors, and surge arresters arranged in series and parallel; and
the submodule capacitor withstands a certain fault voltage, the switching device of the submodule endures the fault currents, and by operating the submodule in a specific switching state, the submodule is integrated into the circuit with a negative voltage, effectively suppressing the fault currents.

As a preferable scheme of the protection method for the embedded multi-port DCPFC under DC short-circuit faults provided by the disclosure,
the protection device is a load shedding circuit connected in parallel with the submodule capacitor, enabling active suppression of step-down fault currents; the protection device is a distributed or centralized fault current limiter, which is composed of thyristor bypass switches, resistors, inductors, and surge arresters connected in series, the distributed fault current limiters are installed within each submodule, and the centralized fault current limiters are connected in parallel with the submodule chains; and by means of the fault current limiter, the rise of fault currents is restricted, assisting a DC grid in suppressing and clearing faults.

Compared with existing flexible interconnection devices, the disclosure has the following beneficial effects.

1. The existing self-balancing series voltage regulation type DCPFC has a relatively complex control system, with limited power flow regulation capability and control flexibility. The external balancing DCPFC currently in use must withstand system-level voltages and insulation, which increases the cost and construction difficulty of the device. In contrast, the proposed multi-port DCPFC, embedded in the MMC, achieves energy balance through coordinated control with the main MMC, eliminating the need for external power sources and isolation transformers. Additionally, the arm of the device is composed of submodules, offering advantages such as modularity, multi-port capability, easy expansion, broad adjustment range, strong regulation ability, suitability for high-voltage systems, and bidirectional controllable power flow.

2. The multi-port DCPFC in this disclosure features a modular design, allowing for rapid and cost-effective expansion of output ports by adjusting the number of DC power flow control units.

3. The main circuit parameter designing method for the DCPFC and the MMC takes into account the impact of embedding the DCPFC on the MMC, providing a fast, effective, and reliable parameter calculation method and selection basis.

4. The protection method for the embedded multi-port DCPFC under DC short-circuit faults not only ensures the safe and stable operation of the DCPFC under extreme DC fault conditions but also effectively suppresses fault currents, assisting a DC grid in suppressing and clearing faults.

### BRIEF DESCRIPTION OF THE DRAWINGS

In order to explain the technical solution in the embodiments of the present disclosure more clearly, the drawings used in the embodiments will be briefly introduced below. Obviously, the drawings in the following description are only some embodiments of the present disclosure, and for those of ordinary skill in the art, other drawings can be obtained according to these drawings without paying creative labor.

FIG. 1 is a schematic diagram of a topological structure of an embedded multi-port DCPFC and a MMC in which the multi-port DCPFC is embedded according to the disclosure;

FIG. 2 is a schematic diagram of a topological structure of an embedded multi-port DCPFC and a MMC in which the multi-port DCPFC is embedded according to the disclosure;

FIG. 3 illustrates a topological diagram of a DC power flow control unit within an embedded multi-port DCPFC, as well as a typical topology example of a unipolar submodule and a bipolar submodule within the embedded multi-port DCPFC according to the disclosure;

FIG. 4 is a typical application scenario diagram of an embedded multi-port DCPFC according to the disclosure;

FIG. 5 is a schematic diagram of a protection method and device for an embedded multi-port DCPFC under DC short-circuit faults according to the disclosure;

FIG. 6 is a schematic diagram of a topological structure of an embedded multi-port DCPFC and a MMC in which the multi-port DCPFC is embedded according to Embodiment 1;

FIG. 7 is a block diagram of a control method of an embedded multi-port DCPFC and a MMC according to Embodiment 1;

FIG. 8 presents simulation waveform graphs for two operating conditions and four stages in Embodiment 1, including the voltage and current waveform graphs of each port, the voltage difference waveform graphs between ports, and the internal submodule capacitor voltage waveform graphs of the MMC and the DCPFC;

FIG. 9 is a schematic diagram of a DC short-circuit fault in Embodiment 2;

FIG. 10 illustrates waveform graphs of submodule capacitor voltages and fault currents of a DCPFC after incorporating a fault protection strategy during a fault in Embodiment 2; and

FIG. 11 illustrates waveform graphs of fault currents and submodule capacitor voltages of a DCPFC after incorporating an active current limitation strategy during a fault in Embodiment 2.

### DETAILED DESCRIPTION OF THE EMBODIMENTS

In order to make the purposes, features and advantages of the disclosure clearer, the embodiments of the disclosure will be described in more detail below in combination with attached drawings. Obviously, the described embodiments are only part of the embodiments of the disclosure, not all of them. Based on the embodiments of the disclosure, all other embodiments obtained by those of ordinary skill in the art without making creative labor shall belong to the scope of protection of the disclosure.

In the following description, specific details are set forth in order to fully understand the disclosure. However, the disclosure can be implemented in many other ways different from those described here, and those skilled in the art can make similar extension without violating the connotation of the disclosure. Therefore, the disclosure is not limited by the specific embodiments disclosed below.

Further, “one embodiment” or “embodiment” here refers to a specific feature, structure or characteristic which can be included in at least one implementation of the disclosure. The appearances of “in one embodiment” in different places of this specification do not all refer to the same embodiment, nor are they separate or selective embodiments mutually exclusive of other embodiments.

The present disclosure will be described in detail with reference to the schematic diagrams. When describing the embodiments of the present disclosure in detail, for the sake of clarity, the cross-sectional view representing the device structure is partially enlarged not to scale, and the said schematic diagram is merely illustrative and should not limit the scope of protection of the present disclosure herein. In addition, the three-dimensional dimensions of length, width and depth should be included in actual production.

In the description of the disclosure, it should be noted that directional or positional relationships indicated by the terms such as “upper”, “lower”, “inner” and “outer” are based on the directional or positional relationships shown in the drawings, which are only for the convenience of describing the disclosure and simplifying the description, but do not indicate or imply that the referred devices or elements must have a specific orientation or be constructed and operated in a specific orientation, so they cannot be understood as limiting the disclosure. In addition, the terms “first”, “second” and “third” are only used for descriptive purposes and cannot be understood as indicating or implying relative importance.

In the description of the disclosure, the terms “install” and “connect” should be understood in a broad sense unless otherwise specified and defined. For example, it may be fixed connection, detachable connection or integrated connection; it may be mechanical connection or electric connection; and it may be direct connection, indirect connection through intermediate media, or internal communication of two elements. For those of ordinary skill in the art, the specific meanings of the above terms in the disclosure may be understood according to specific situations.

### Embodiment 1

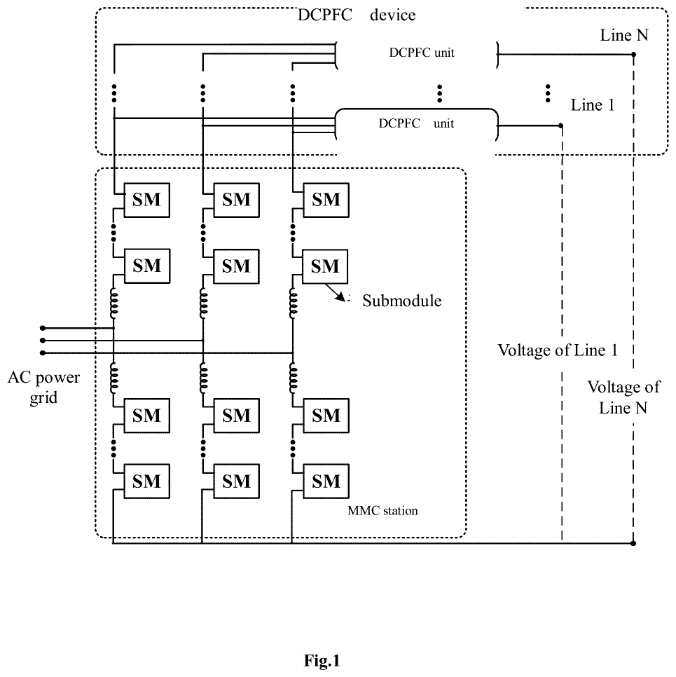

Referring to FIGS. 1-6, a first embodiment of the disclosure provides a flexible DC converter featuring multi-port DC power flow control and a control method thereof. The flexible DC converter comprises:
a MMC; and
a DCPFC embedded within the MMC.

Further, the DCPFC comprises two or more DC power flow control units, the number of the DC power flow control units is equal to the number of ports of the DCPFC, and each DC power flow control unit is capable of adjusting the DC power flow on a connected DC line;
the DC power flow control unit consists of a three-phase star-connected submodule chain and an arm inductor, and a three-phase neutral point resulting from the connection of the submodule chain and the inductor serves as a DC power flow regulation port; and
the MMC is a medium- or high-voltage, three-phase voltage source converter with a modular multilevel structure, capable of AC-DC power conversion, facilitating the interconnection of medium- and high-voltage AC power grids with DC systems.

Further, the MMC is a modular multilevel converter with medium to high voltage rating.

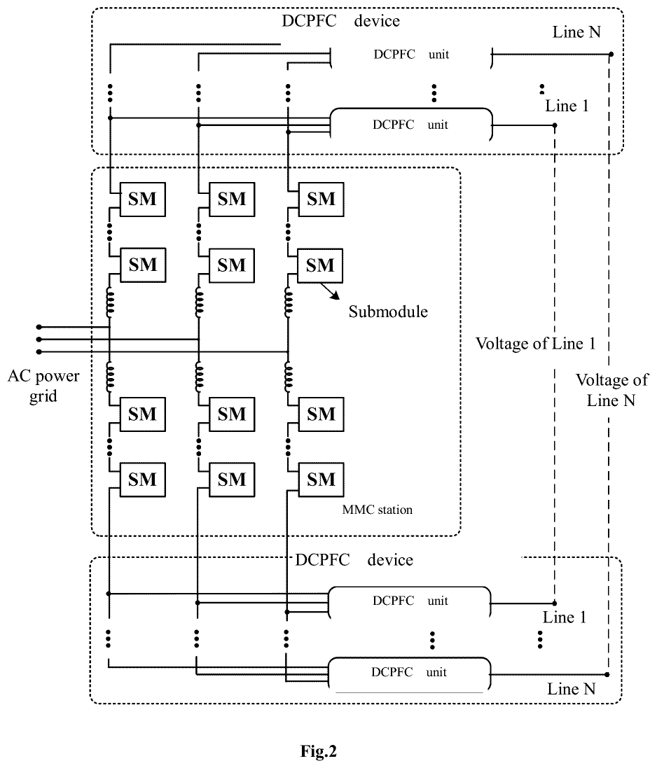

Further, as shown in FIGS. 1 and 2, the embedded DCPFC is symmetrically installed on both upper and lower arms of the MMC, or installed on either the upper arm or the lower arm of the MMC.

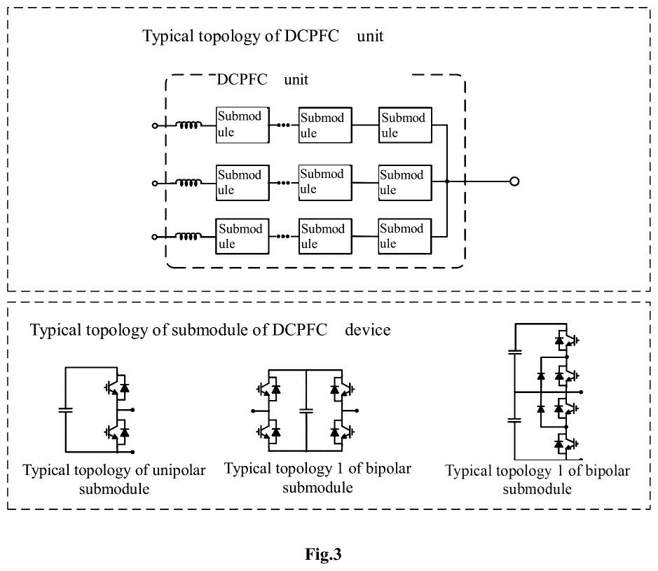

Further, as shown in FIG. 3, the submodule chain is a unipolar submodule chain, a bipolar submodule chain, or a hybrid submodule chain comprising both unipolar and bipolar submodules.

The disclosure also provides a control method of the embedded multi-port DCPFC, which comprises DC power flow control loops on multiple lines, energy balance control loops between the MMC and the DCPFC, and internal energy balance control loops within the DCPFC, wherein
when the embedded multi-port DCPFC connects two or more DC lines, the sum of power on all output lines equals the total power of the MMC; if the embedded multi-port DCPFC connects a total of N DC output lines, it is possible to perform active control on the power flow of N−1 lines, while the DC power flow on the remaining line equals the total power flow minus the sum of the power flow on the other lines.

Further, the control objective of the line power flow control loop is to ensure that the DC voltage of N output lines equals a reference value.

It should be noted that N represents the total number of lines connected to the embedded multi-port DCPFC. The line power flow control loop first selects a line with the relatively lowest voltage as a reference line based on output line voltage reference values provided by an external system.

Additionally, the DC component of the voltage in the internal submodule chain of the DC power flow control unit connected to the reference line is set to zero. The line power flow control loop calculates a difference between voltage reference values of other lines and a reference circuit voltage to determine DC components of voltages of each DC power flow control unit, and the mathematical equation is as follows:

$$\{ \begin{matrix}{U}_{p 1 a , dc} = {U}_{o 1} - {U}_{d} \\ {U}_{p k a , d c} = {U}_{o k} - {U}_{d} \\ {U}_{pNa , dc} = {U}_{oN} - {U}_{d}\end{matrix}$$

where U_{d} is a rated voltage of a DC system, which is also equal to a reference line voltage; Uₚ₁ₐ, Uₚₖₐ and U_{pNa} are the DC components of the voltages of the DC power flow control units connected to the first line, the k^{th} line, and the N^{th} line respectively; and Uₒₗ, Uₒₖ and U_{oN} are DC voltage reference values of the first line, the k^{th} line, and the N^{th} line respectively.

Further, the control objective of the energy balance control loop between the MMC and the DCPFC is to maintain an average voltage of all submodule capacitors within the DCPFC at a reference value.

It should be noted that during the process of controlling DC power flow, the DCPFC interacts with a DC system, leading to the exchange of DC energy. The accumulation of DC energy causes the voltage of the internal submodule capacitors in the DCPFC to lose stability. The energy balance control loops between the MMC and the DCPFC superimpose energy balancing control voltages on arms of the DC flow power control units and arms of the modular multilevel converter, thus forming AC coupled energy. The mathematical equation for the overall input and output energy of the DCPFC is as follows:

$$\{ \begin{matrix}{P}_{DCPFC \_ out} = {\sum }_{i = 1}^{N} ( {U}_{p i a , d c} - \frac{1}{N} {\sum }_{l = 1}^{N} {U}_{pla , dc} ) {I}_{o i} \\ {P}_{DCPFC \_ in} = {\sum }_{j = a , b , c} {i}_{jp , a c} ( \frac{1}{N} {\sum }_{i = 1}^{N} {U}_{pij , ac} ) + ( \frac{1}{N} {\sum }_{i = 1}^{N} {U}_{pia , dc} ) {I}_{d}\end{matrix}$$

where P_{DCPFC_out} is the total output energy of the multi-port DCPFC, P_{DCPFC_in} is the total input energy of the multi-port DCPFC, U_{pia,dc} and U_{pia,ac} are DC and AC components of a voltage of the DC power flow control unit connected to the i^{th} line respectively, Iₒᵢ is a DC current of the i^{th} line, I_{d} is the sum of DC currents of all lines, and i_{jp,ac} is an AC component of an upper arm current in phase j of the MMC.

Further, to ensure the stable operation of the DCPFC, the output power of a power flow regulation port of the DCPFC must balance with the input power of an energy balance port, as described by the following mathematical equation.

P_{DCPFC_out}=P_{DCPFC_in}

It should be noted that a proportional-integral controller is used to control the amplitude and phase angle of the energy balance control voltage of the DCPFC and the MMC. The input is the difference between the average voltage of all submodules within the DCPFC and a reference value, and the output is reference values of the amplitude and phase angle of the energy balance control voltage.

Further, to ensure that the phase angle of the energy balance control voltage always equals the phase angle of the arm current of the MMC, it is sufficient to control the magnitude of the energy balance control voltage, ensuring that the magnitudes of the three-phase energy balance control voltages are equal. The equation for the proportional-integral controller is as follows:

$${U}_{PFC , ac}^{*} = {k}_{p} ( {U}_{c}^{*} - \frac{1}{N} {\sum }_{i = 1 , 2 , … , N} {U}_{C , i} ) + \int {k}_{i} ( {U}_{c}^{*} - \frac{1}{N} {\sum }_{i = 1 , 2 , … , N} {U}_{C , i} ) dt$$

where kₚ is the gain coefficient of the proportional part of the proportional-integral controller, kᵢ is the gain coefficient of the integral part of the proportional-integral controller, U_{C*} is the reference value of the voltage of the internal submodule capacitors in the DC power flow control units, U_{C,i} is the average voltage of the internal submodule capacitors in the k^{th} DC power flow control unit, and U_{PFC*} is the reference value of the magnitude of the energy balance control voltage between the DCPFC and the MMC. N denotes the total number of lines connected to the embedded multi-port DCPFC.

Further, the control objective of the internal energy balance control loop of the DCPFC is to maintain consistent internal submodule capacitor voltages of each DC power flow control unit.

It should be noted that the line power flow control loop results in differing DC voltages for the DC power flow control units, creating DC energy deviation that lead to inconsistencies in internal submodule capacitor voltages of each DC power flow control unit. Therefore, the internal energy balance control loop of the DCPFC actively injects AC circulating currents between the DC power flow control units, using AC coupled energy to compensate for the DC energy deviation and maintain stable submodule voltages and energy balance. The calculation formula for the DC energy of each DC power flow control unit is as follows:

$$Δ {p}_{k} = ( {U}_{pka , dc} - \underline{\frac{1}{N} {\sum }_{i = 1}^{N} {U}_{pia , dc}} ) {I}_{o k} , k = 1 , 2 … N$$

where Δpₖ is the DC energy of the k^{th} DC power flow control unit, U_{pka,dc} and U_{pia,dc} are DC components of voltages of the DC power flow control units connected to the k^{th} and i^{th} lines respectively, Iₒₖ is the DC current of the k^{th} line, and N denotes the total number of lines connected to the embedded multi-port DCPFC.

Further, each DC power flow control unit injects AC voltages under the control of the internal energy balance control loop of the DCPFC, and the mathematical equation is as follows:

$$Δ {u}_{c k a} = {x}_{k} sin ( ω t - {β}_{k} ) , k = 1 , 2 … N$$

where Δu_{cka} is the positive sequence circulating voltage additionally superimposed in the a-phase modulation voltage of the k^{th} DC power flow control unit, xᵢ and βᵢ are the amplitude and phase angle of the fundamental frequency positive sequence circulating voltage respectively, and ω is angular frequency.

It should be noted that the actively injected AC voltage causes AC coupled energy to be generated inside the DCPFC, and the mathematical equation of the average value of the AC coupled energy in the fundamental frequency period is as follows:

$$\overline{Δ {p}_{c k a}} = \overline{Δ {i}_{c k a} {u}_{p k a , a c}} = \frac{{U}_{PFC , ac}}{ω {NL}_{PFC}} [ \text{} ( N - 1 ) {x}_{k} cos ( {δ}_{PFC} + \frac{π}{2} - {β}_{k} ) - {\sum }_{{i = 1}_{i \neq k}}^{N} {x}_{i} cos ( {δ}_{PFC} + \frac{π}{2} - {β}_{i} ) ] , k = 1 , 2 … N$$

where Δp_{cka} is the AC coupled energy of the k^{th} DC power flow control unit, L_{PFC} is the arm inductance value in the DC power flow control unit, U_{PFC,ac} and δ_{PFC} are the amplitude and phase angle of the energy balance control voltage between the MMC and the DCPFC respectively, xₖ and xᵢ are the circulating voltage amplitude of the k^{th} and i^{th} DC power flow control units respectively, and βₖ and βᵢ are the circulating voltage phase angles of the k^{th} and i^{th} DC power flow control units respectively.

Further, to realize the energy balance between the DC power flow control units, the internal energy balance control loop of the DCPFC compensates the DC energy deviation with the AC coupled energy by controlling the amplitude and phase angle of circulating voltage, that is, the sum of AC coupled energy and DC energy deviation is zero. Additionally, the sum of AC coupled energy of all the DC power flow control units is also zero. The mathematical equation for the energy relationship within the DCPFC is as follows:

$$\frac{Δ {p}_{1}}{3} + \underline{Δ {p}_{c 1 a}} = ⋯ = \frac{Δ {p}_{k}}{3} + \underline{Δ {p}_{c k a}} = ⋯ = \frac{Δ {p}_{N}}{3} + \underline{Δ {p}_{cNa}} , {\sum }_{i = 1}^{N} \underline{Δ {p}_{c i a}} = 0$$

where Δp₁, Δpₖ and Δp_{N} are DC energy of the first, k^{th} and N^{th} DC power flow control units respectively, and Δp_{c1a}, Δp_{cka} and Δp_{cNa} are AC coupled energy of the first, k^{th} and N^{th} DC power flow control units respectively.

It should be noted that a proportional-integral controller is used to control the amplitude and phase angle of circulating voltage of the DC power flow control units. The input is the difference between the internal submodule voltage of each DC power flow control unit and the average value of submodule voltages of all the DC power flow control units, and the output is reference values of the amplitude and phase angle of circulating voltage of the corresponding DC power flow control unit.

Further, if the reference values of circulating voltage phase angles of all the DC power flow control units are equal and only the amplitude of circulating voltage is controlled, the equation of the proportional-integral controller is as follows:

$${x}_{k}^{*} = {k}_{p} ( {U}_{C , k} - \frac{1}{N} {\sum }_{i = 1 , 2 , … , N} {U}_{C , i} ) + \int {k}_{i} ( {U}_{C , k} - \frac{1}{N} {\sum }_{i = 1 , 2 , … , N} {U}_{C , i} ) dt$$

where kₚ is the gain coefficient of the proportional part of the proportional-integral controller, kᵢ is the gain coefficient of the integral part of the proportional-integral controller, U_{C,k} and U_{C,i} are the average voltages of the internal submodule capacitors in the k^{th} and i^{th} DC power flow control units respectively, xₖ is the reference value of the circulating voltage amplitude of the k^{th} DC power flow control unit, and N denotes the total number of lines connected to the embedded multi-port DCPFC.

The disclosure also provides a main circuit parameter designing method for the embedded multi-port DCPFC, which comprises the design of the number of submodules of the DC power flow control unit and the MMC, the design of the capacitance of submodules of the DC power flow control unit and the MMC, the design of the arm inductance of the DCPFC, and the design of power devices of submodules of the DC power flow control unit and the MMC.

It should be noted that the DCPFC is installed asymmetrically, embedded at an end of the upper arm of the MMC.

It should also be noted that the DCPFC uses bipolar full-bridge submodules, and the MMC employs unipolar half-bridge submodules.

It should also be noted that the multi-port DCPFC is connected with two DC lines.

Further, the objective of the design of the number of submodules of the DC power flow control unit and the MMC is to select an appropriate number of submodules for the DCPFC and the arms of the MMC, so as to avoid the problems of over-modulation and insufficient DC power flow control range. When the external parameters of the system are determined, according to the designing method for the number of submodules of the DC power flow control unit, the lower limit of the number of submodules of the DC power flow control unit and the lower limit of the number of submodules of the MMC can be quickly calculated.

The mathematical equation for selecting the number of submodules of the DCPFC is as follows:

$${N}_{PFC} \geq \frac{ε {U}_{d}}{2 {U}_{CPFC}} + \frac{1}{{U}_{CPFC}} \sqrt{{( 2 ε E \frac{Δ {P}_{1 , 2} cos ( φ - δ )}{P} )}^{2} + {( \frac{ω {L}_{PFC}}{6 E} \cdot \frac{P}{Δ {P}_{1 , 2} cos ( φ - δ )} )}^{2}} \geq \frac{ε {U}_{d}}{2 {U}_{CPFC}}$$

where N_{PFC} is the number of submodules in a submodule chain in the DCPFC, U_{CPFC} is a rated voltage of the submodules in the DCPFC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
the mathematical equation for selecting the number of submodules of the MMC is as follows:

$$\{ \begin{matrix}{N}_{MMC \_ p} \geq [ \frac{1}{2} - \frac{ε Δ {P}_{1 , 2}}{4 P} ] \frac{{U}_{d}}{{U}_{C}} + \frac{1}{{U}_{C}} \sqrt{{E}^{2} + {[ ε \frac{Δ {P}_{1 , 2} E cos ( φ - δ )}{P} ]}^{2} + {( \frac{ω {L}_{PFC} P}{12 E cos ( φ - δ )} )}^{2}} \\ {N}_{MMC \_ n} \geq [ \frac{1}{2} + \frac{ε Δ {P}_{1 , 2}}{4 P} ] \frac{{U}_{d}}{{U}_{C}} + \frac{1}{{U}_{C}} \sqrt{{E}^{2} + {( \frac{ω {L}_{PFC} P}{12 E cos ( φ - δ )} )}^{2}}\end{matrix}$$

where N_{MMC,p} and N_{MMC,n} are the number of submodules of the upper arm and lower arm of the MMC respectively, U_{C} is a rated voltage of the submodules of the MMC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

Further, the objective of the design of the capacitance of submodules of the DC power flow control unit and the MMC is to select appropriate submodule capacitance for the DCPFC and the arms of the MMC, so as to control the voltage ripple in a reasonable range. Due to the influence of the DC power flow control unit on the MMC, the capacitance parameter designing method is different from that of traditional MMCs. When the external parameters of the system are determined, according to the designing method for the capacitance of submodules of the DC power flow control unit, the lower limit of the capacitance value of submodules of the DC power flow control unit and the lower limit of the capacitance value of submodules of the MMC can be quickly calculated.

The mathematical equation for selecting the capacitance value of submodules of the DCPFC is as follows:

$$\{ \begin{matrix}{C}_{PFC} \geq \frac{1}{{r}_{1}} \cdot \frac{1}{{N}_{PFC} {U}_{CPFC}} \sqrt{{{ε}^{2} [ \frac{1.6}{11 ω cos ( φ - δ )} + \frac{2 P cos ( φ - δ )}{11 ω} ]}^{2} + {[ \frac{{L}_{PFC} {P}^{2}}{16 {E}^{2}} ]}^{2}} \\ {C}_{PFC} \geq \frac{1}{{r}_{2}} \cdot \frac{1}{{N}_{PFC} {U}_{CPFC}} \sqrt{{[ \frac{{L}_{PFC} {P}^{2} [ 2 cos ( φ - δ ) - 1.8 ]}{259 {E}^{2} cos ( φ - δ )} ]}^{2} + {{ε}^{2} [ \frac{[ 2 cos ( φ - δ ) - 1.8 ] P}{86 ω} ]}^{2}}\end{matrix}$$

where CPFC is the capacitance of the submodules of the DCPFC, N_{PFC} is the number of submodules in a submodule chain in the DCPFC, U_{CPFC} is a rated voltage of the submodules in the DCPFC, r₁ and r₂ are fundamental frequency and double frequency fluctuation rates of a submodule capacitor voltage respectively, ε is a ratio of a maximum regulating voltage of the DCPFC to a rated voltage of a DC grid, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
the mathematical equation for selecting the capacitance value of modular multilevel submodules is as follows:

$$\{ \begin{matrix}{C}_{0} \geq \frac{1}{{ε}_{1}} \cdot \vert \frac{3 P}{10 ω {N}_{MMC}^{2} {U}_{C}^{2} cos ( φ - δ )} \vert \\ {C}_{0} \geq \frac{1}{{ε}_{2}} \cdot \vert \frac{P}{12 ω {N}_{MMC}^{2} {U}_{C}^{2} cos ( φ - δ )} \vert\end{matrix}$$

where C₀ is the capacitance of the submodules of the MMC, N_{MMC} is the number of submodules in one arm of the MMC, U_{C} is a rated voltage of submodule capacitors of the MMC, ε₁ and ε₂ are fundamental frequency and double frequency fluctuation rates of a submodule capacitor voltage of the MMC respectively, P is the total power of the MMC, φ is a phase angle of an AC current of the MMC, and δ is a phase angle difference between a fundamental AC component of an arm voltage of the MMC and a grid voltage.

Further, the objective of the design of the arm inductance of the DCPFC is to select an appropriate arm inductance value for the DCPFC, so as to meet the capacity requirements of power transmission, reduce negative sequence currents, suppress short-circuit fault currents, and form the resonant angular frequency of series resonance between submodule chains and arm inductance within phase units of appropriate size. When the external parameters of the system are determined, according to the designing method for the arm inductance of the DCPFC, the value range of the arm inductance of the DCPFC can be quickly calculated.

The mathematical equation for selecting the arm inductance of the DCPFC is as follows:

$$\{ \begin{matrix}AC negative sequence current constraint : \\ {L}_{PFC} \geq \frac{2}{{ω}_{0}} sin ( 2 arc sin ( \frac{1.5 \%}{η} ) ) - 4 {L}_{T} - 2 {L}_{0} \\ Internal energy balance constraint for DCPFC device : \\ {L}_{PFC} \leq \frac{3 {N}_{PFC} {U}_{CPFC}}{4 {I}_{d} {ω}_{0}} \\ Short - circuit fault current suppression limit : \\ {L}_{PFC} \geq \frac{( 2 + ε ) {U}_{d}}{λ} - 12 {L}_{d c} - 4 {L}_{0} \\ Resonant frequency limit for phase unit : \\ {ω}_{res} = \sqrt{\frac{{N}_{MMC}^{2} + {N}_{PFC}^{2}}{( 4 {L}_{0} + {L}_{PFC} ) ( {N}_{MMC} + {N}_{PFC} ) {C}_{0}}} \approx {ω}_{0}\end{matrix}$$

where L_{PFC} is the arm inductance of the DCPFC, ω₀ is angular frequency at the fundamental frequency, ωᵣₑₛ is resonant angular frequency of the series resonance formed between the submodule chain and arm inductance within a phase unit of an integrated system of the DCPFC and the MMC, L_{T} is an inductance value of a connected transformer, L₀ is an arm inductance value of the MMC, L_{dc} is an inductance value of a smoothing reactor of a DC system, N_{PFC} is the number of submodules in a submodule chain of the DCPFC, U_{CPFC} is a rated voltage of submodules in the DCPFC, U_{d} is a rated voltage of a DC grid, I_{d} is a rated current of the DC grid, ε is a ratio of a maximum regulating voltage of the DCPFC to the rated voltage of the DC grid, λ is an upper limit of a transient current change rate under short-circuit faults, η is a per-unit value of a negative sequence current amplitude, C₀ is the capacitance of submodules of the MMC, and N_{MMC} is the number of submodules in one arm of the MMC.

Further, the objective of the design of power devices of submodules of the DC power flow control unit and the MMC is to select appropriate power electronic devices for submodules of the DCPFC and the MMC. When the external parameters of the system are determined, according to the designing method for the power devices of submodules of the DC power flow control unit and the MMC, the voltage and current stresses of the power electronic devices can be determined.

The mathematical equation for calculating the voltage and current stresses of the power devices of the DC power flow control unit is as follows:

$$\{ \begin{matrix}\begin{matrix}{A}_{PFC \_ U} = \frac{ε {U}_{d}}{4 {N}_{PFC}} + \\ \frac{1}{2 {U}_{d} {N}_{PFC}} \sqrt{{( \frac{Δ {P}_{1 , 2} E cos ( φ - δ )}{P} )}^{2} + {( \frac{ω {L}_{PFC} P}{3} )}^{2}}\end{matrix} \\ \begin{matrix}{A}_{PFC \_ Ures} = \frac{ε {U}_{d}}{4 {N}_{PFcC}} + \\ \frac{1}{4 {U}_{d} {N}_{PFC}} \sqrt{2 {( \frac{Δ {P}_{1 , 2} E cos ( φ - δ )}{P} )}^{2} + 2 {( \frac{ω {L}_{PFC} P}{3} )}^{2}}\end{matrix}\end{matrix}$$

$$\{ \begin{matrix}{A}_{PFC \_ I} = \frac{max \{ {P}_{1} , {P}_{2} \}}{3 {U}_{d}} + P \sqrt{{( \frac{1}{6 E cos ( φ - δ )} )}^{2} + {( \frac{1}{3 {U}_{d}} )}^{2}} \\ {A}_{PFC \_ Ires} = \frac{max \{ {P}_{1} , {P}_{2} \}}{3 {U}_{d}} + \frac{P \sqrt{2 {( \frac{1}{6 E cos ( φ - δ )} )}^{2} + 2 {( \frac{1}{3 {U}_{d}} )}^{2}}}{2}\end{matrix}$$

where A_{PFC_U} and A_{PFC_Ures} are peak and effective values of a maximum voltage withstood by a single power electronic device in an arm submodule of the DCPFC respectively, A_{PFC_I} and A_{PFC_Ires} are peak and effective values of a maximum current withstood by a single power electronic device in the arm submodule of the DCPFC respectively, P₁ and P₂ are the DC power flow of two DC lines, ΔP_{1,2} is a maximum difference between the DC power flow of the two DC lines, ε is a ratio of a maximum regulating voltage of the DCPFC to a rated voltage of a DC grid, U_{d} is the rated voltage of the DC grid, N_{PFC} is the number of submodules in a submodule chain of the DCPFC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and

It should be noted that the current and voltage stresses of the upper and lower arms of the MMC in which the DCPFC is embedded differ from those in traditional operating modes.

Further, the mathematical equation for calculating the voltage and current stresses of the power devices of the MMC is as follows:

$$\{ \begin{matrix}{A}_{{MMC}_{U}} = \frac{1}{2 {N}_{MMC}} \{ [ \frac{1}{2} + \frac{Δ {P}_{1 , 2}}{2 {EU}_{d} cos ( φ - δ )} ] {U}_{d} + \sqrt{{E}^{2} + {( \frac{Δ {P}_{1 , 2} E cos ( φ - δ )}{{PU}_{d}} )}^{2} + {( \frac{ω {L}_{PFC} P}{12 E cos ( φ - δ )} )}^{2}} \} \\ {A}_{MMC \_ Ures} = \frac{1}{2 {N}_{MMC}} \{ \frac{[ \frac{1}{2} + \frac{Δ {P}_{1 , 2}}{2 {EU}_{d} cos ( φ - δ )} ] {U}_{d} + \sqrt{{E}^{2} + 2 {( \frac{Δ {P}_{1 , 2} E cos ( φ - δ )}{{PU}_{d}} )}^{2} + 2 {( \frac{ω {L}_{PFC} P}{12 E cos ( φ - δ )} )}^{2}}}{2} \}\end{matrix}$$

$$\{ \begin{matrix}{A}_{MMC \_ I} = \frac{P}{3 {U}_{d}} + \frac{P}{3 E cos ( φ - δ )} \\ {A}_{MMC \_ Ires} = \frac{P}{3 {U}_{d}} + \frac{\sqrt{2} P}{6 E cos ( φ - δ )}\end{matrix}$$

where A_{MMC_U} and A_{MMC_Ures} are peak and effective values of a maximum voltage withstood by a single power electronic device in an arm submodule of the MMC respectively, A_{MMC_I} and A_{MMC_Ires} are peak and effective values of a maximum current withstood by a single power electronic device in the arm submodule of the MMC respectively, ΔP_{1,2} is a maximum difference between the DC power flow of two DC lines, U_{d} is a rated voltage of a DC grid, N_{MMC} is the number of submodules in one arm of the MMC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

The disclosure also provides a protection method for the embedded multi-port DCPFC under DC short-circuit faults, which comprises the protection of the DCPFC under DC short-circuit faults, and the active restriction of fault currents under DC short-circuit faults.

Further, the protection of the DCPFC under DC short-circuit faults comprises: controlling the submodules within the DCPFC to operate in a specific switching state, or installing a protection device on the submodules within the DCPFC.

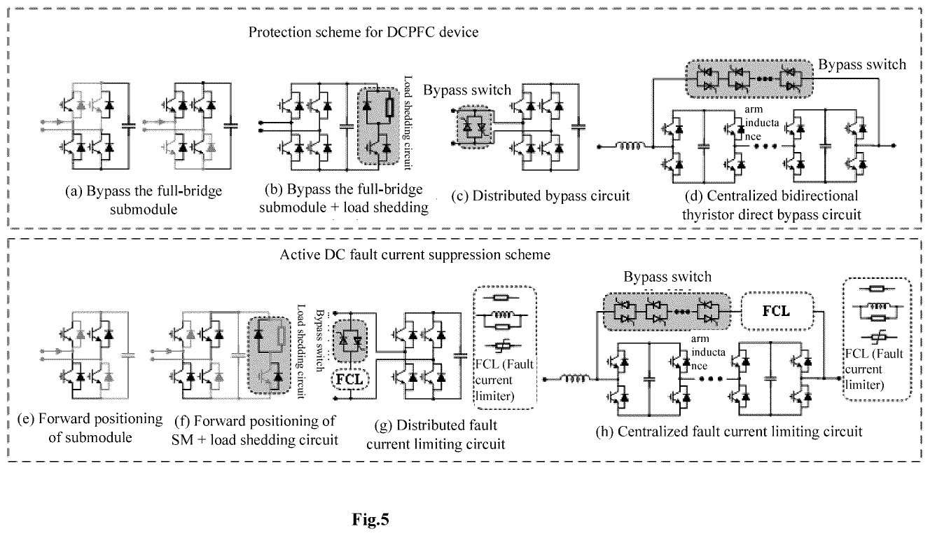

Further, the specific switching state of the submodule refers to the condition where a submodule capacitor is bypassed and currents flow solely through a switching device, and the protection device consists of a load shedding circuit or a thyristor bypass switch; and
it should be noted that if the switching device of the submodule can withstand fault currents, by operating the submodule in the specific switching state, as shown in FIG. 5(a), the fault currents are prevented from flowing into the submodule capacitor, thus achieving fault protection.

It should be noted that the purpose of this method is to prevent damage to the DCPFC due to overvoltage on the submodule capacitors or overcurrent on the submodule switching devices during DC short-circuit faults.

Further, the protection device is a load shedding circuit connected in parallel with the submodule capacitor, as shown in FIG. 5(b), the load shedding circuit is formed by a combination of diodes, resistors, and switching devices in series and parallel, which dissipates the energy of the fault currents to prevent overvoltage across the submodule capacitor, thereby achieving fault protection.

It should be noted that the protection device is a distributed or centralized thyristor bypass switch, and the thyristor bypass switch consists of anti-parallel thyristors, a resistor-capacitor circuit, and static resistors connected in parallel; as shown in FIG. 5(c), the distributed thyristor bypass switches are installed within each submodule; as shown in FIG. 5(d), the centralized thyristor bypass switches are connected in parallel with the submodule chains; and the submodules are bypassed through the fast action of the bidirectional thyristors, preventing the fault currents from flowing through the submodules, thus achieving fault protection.

Further, the active restriction of fault currents under DC short-circuit faults of the DCPFC comprises: controlling the submodules within the DCPFC to operate in a specific switching state, or installing a protection device on the submodules within the DCPFC.

It should be noted that the specific switching state of the submodule refers to the condition where the submodule is locked or positively engaged, the protection device consists of a load shedding circuit and a fault current limiter, the load shedding circuit is formed by a combination of diodes, resistors, and switching devices arranged in series and parallel, and the fault current limiter is formed by a combination of resistors, inductors, and surge arresters arranged in series and parallel.

Further, if the submodule capacitor can withstand a certain fault voltage and the switching device of the submodule can endure the fault currents, by operating the submodule in a specific switching state, as shown in FIG. 5(e), the submodule is integrated into the circuit with a negative voltage, effectively suppressing the fault currents.

It should be noted that the purpose of this method is to utilize the DCPFC to assist a DC grid in suppressing and clearing faults.

It should be noted that the protection device is a load shedding circuit connected in parallel with the submodule capacitor, as shown in FIG. 5(f), enabling active suppression of step-down fault currents.

It should be noted that the protection device is a distributed or centralized fault current limiter, which is composed of thyristor bypass switches, resistors, inductors, and surge arresters connected in series; as shown in FIG. 5(g), the distributed fault current limiters are installed within each submodule; as shown in FIG. 5(h), the centralized fault current limiters are connected in parallel with the submodule chains; and by means of the fault current limiter, the rise of fault currents is restricted, assisting a DC grid in suppressing and clearing faults.

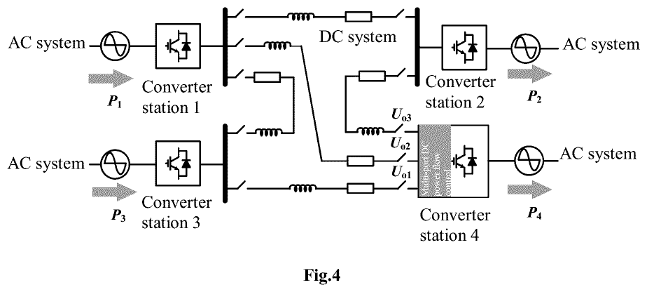

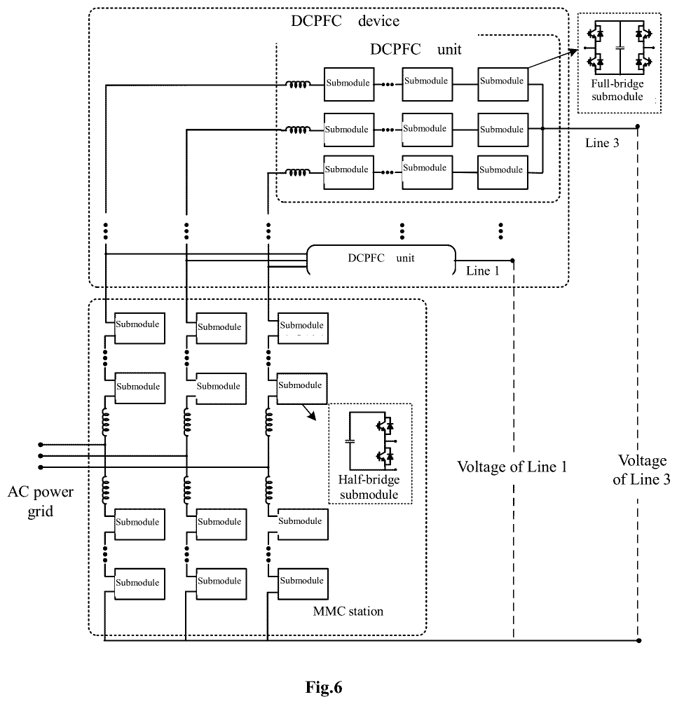

In Embodiment 1, the installation scene and the specific topology of a DCPFC are shown in FIGS. 4 and 6. The disclosure uses a multi-port DCPFC embedded in a MMC to realize the power flow control of three DC lines. The MMC is a MMC. The multi-port DCPFC is installed asymmetrically, embedded at an end of an upper arm of the MMC. The multi-port DCPFC comprises three DC power flow control modules, each DC power flow control module comprises three-phase star-connected arms, and each arm consists of a bipolar full-bridge submodule chain and an arm inductor. By adjusting the amplitude and phase of the DC voltage and AC voltage on the DC power flow control module, energy balance can be achieved between the DCPFC and the MMC, as well as internal energy balance within the multi-port DCPFC. Additionally, active control of the DC power flow on three output lines can be realized.

For the system illustrated in FIG. 6, which is based on the multi-port DCPFC, the DC voltage of the multi-port DCPFC is adjusted through DC power flow control loops, thereby altering the DC voltage of the output lines and achieving control of the DC power flow. The energy balance between the DCPFC and the MMC, as well as the internal energy balance of the multi-port flexible AC interconnection device, is controlled through energy balance control loops between the MMC and the DCPFC, and internal energy balance control loops of the DCPFC, ensuring stable capacitor voltages across all submodules of the multi-port DCPFC.

### Embodiment 2

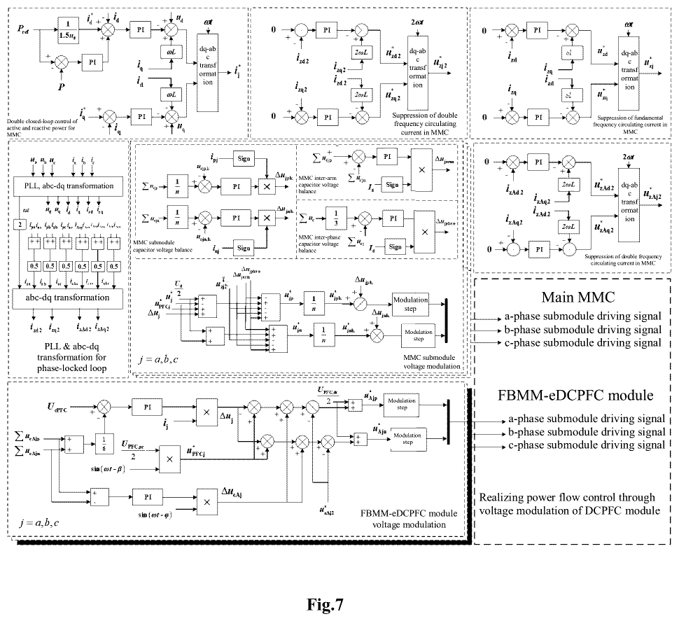

Referring to FIGS. 7-11, the submodule topology of the multi-port DCPFC is consistent with Embodiment 1; however, the number of lines connected to the DCPFC is changed to two. In this embodiment, the multi-port DCPFC is controlled through active restriction of fault currents under DC short-circuit faults. When a DC short-circuit fault occurs, both the fault protection method for the DCPFC under DC short-circuit faults and the active fault current restriction method are applied to suppress the rise in submodule capacitor voltages of the DCPFC and to control the increase in fault currents, ensuring stable operation of the device under complex extreme conditions and assisting the DC grid in suppressing and clearing faults.

In this embodiment, the principles for achieving multi-line DC power flow control, energy balance between the multi-port DCPFC and the MMC, as well as internal energy balance of the multi-port DCPFC, are the same as those in the previous embodiment, which will not be repeated here.

The following provides further explanation of the application of the structures and methods in the two aforementioned embodiments, combined with specific simulation examples.

Based on the previous embodiments, MATLAB/Simulink software is used for system simulation and validation, with simulation parameters as shown in Table 1.

TABLE 1
Simulation parameters

| Parameter | Numerical value | |
|---|---|---|
| Rated capacity of MMC | 1500 | MVA |
| DC rated voltage | 500 | kV |
| AC rated voltage | 260 | kV |
| Submodule capacitance of MMC | 15 | mF |
| Number of submodules of arm of MMC | 233 | |
| Submodule bus voltage of MMC | 2300 | V |
| Arm inductance of MMC | 8 | mH |
| Number of DC power flow control units | 3 | |
| Number of submodules of arm of DCPFC | 10 | |
| Submodule capacitance of DCPFC | 15 | mF |
| Submodule capacitor voltage of DCPFC | 2300 | V |
| Arm inductance of DCPFC | 1.4 | mH |
| Line resistance R1 | 5.0Ω | |
| Line resistance R2 | 2.0Ω | |
| Line resistance R3 | 3.0Ω | |
| Line inductance L1 | 192 | mH |
| Line inductance L2 | 174 | mH |
| Line inductance L3 | 184 | mH |

### Simulation Example 1

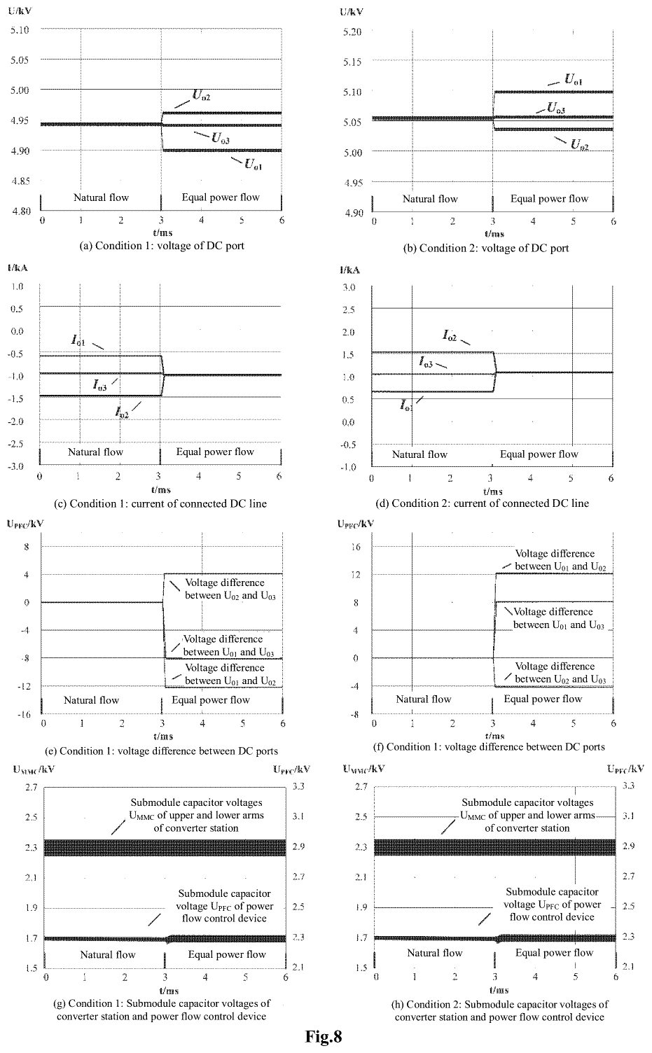

Embodiment 1 features a multi-port DCPFC embedded within a MMC, with its installation position in a DC system illustrated in FIG. 4. The specific topology of the DCPFC and the MMC is shown in FIG. 7, and the control method for Embodiment 1 is depicted in FIG. 8. The multi-port DCPFC is connected to three DC lines and controls the DC power flow by adjusting the DC voltage of output ports, corresponding to DC power flow control loops. The DCPFC is embedded into the MMC to achieve overall energy balance through coordinated control, corresponding to energy balance control loops between the MMC and the DCPFC. Inside the DCPFC, energy balance among the submodules is achieved by injecting fundamental frequency circulating current, corresponding to internal energy balance control loops of the DCPFC.

To verify the power flow control capability of the multi-port DCPFC, the stability of energy balance control within the device, and the rationality of the main circuit parameter design, simulations are conducted based on two operating conditions set according to the power direction of the MMC. Each operating condition is divided into two stages: the power flow distribution during uncontrolled power flow and controlled power flow. The specific operating conditions are designed as follows:

### Condition 1 (Rectification Mode):

Stage One (Natural Flow): The rectification power of the MMC is 1500 MW. In this case, the DCPFC is inactive, so the DC line power flow is distributed naturally according to line impedance. Since the resistances of the three DC lines are different, the currents in the three DC lines are not consistent, as shown in FIG. 8(c) within the interval [0˜3 s];

Stage Two (Controlled Flow): By utilizing DC voltage differences at each port of the DCPFC, port voltages and port voltage differences are shown in FIGS. 8(a) and 8(e). This control ensures that the currents in the DC lines connected to the three DC ports are consistent, as illustrated in FIG. 8(c) within the interval [3˜6 s]. The internal submodule capacitor voltage waveform graphs of the MMC and the DCPFC for Condition 1 are shown in FIG. 8(g).

### Condition 2 (Inversion Mode):

Stage One (Natural Flow): The inversion power of the MMC is 1500 MW. In this case, the DCPFC is inactive, so the DC line power flow is distributed naturally according to line impedance. Since the resistances of the three DC lines are different, the currents in the connected DC lines are not consistent, as shown in FIG. 8(d) within the interval [0˜3 s];

Stage Two (Controlled Flow): By utilizing DC voltage differences at each port of the DCPFC, port voltages and port voltage differences are shown in FIGS. 8(b) and 8(f). This control ensures that the currents in the DC lines connected to the three DC ports are consistent, as illustrated in FIG. 8(d) within the interval [3˜6 s]. The internal submodule capacitor voltage waveform graphs of the MMC and the DCPFC for Condition 2 are shown in FIG. 8(h).

FIG. 8 presents the simulation results for Condition 1 and Condition 2 in Embodiment 1, consisting of eight waveform graphs. Shown from left to right and top to bottom are: the DC voltage waveform graphs of the line ports for Condition 1 and Condition 2, the DC current waveform graphs of the line ports for Condition 1 and Condition 2, the DC voltage difference waveform graphs of the line ports for Condition 1 and Condition 2, and the internal submodule capacitor voltage waveform graphs of the MMC and the DCPFC for Condition 1 and Condition 2.

The simulation waveform results indicate that, under different DC current directions, the embedded multi-port DCPFC can effectively regulate the power flow in multiple DC lines and possesses the capability for bidirectional power flow control. The energy balance control loops between the MMC and the DCPFC, as well as the internal energy balance control loops of the DCPFC, can effectively maintain the energy balance of the submodules of the device. Additionally, the main circuit parameter designing method can effectively select the electrical parameters of the main circuit.

### Simulation Example 2

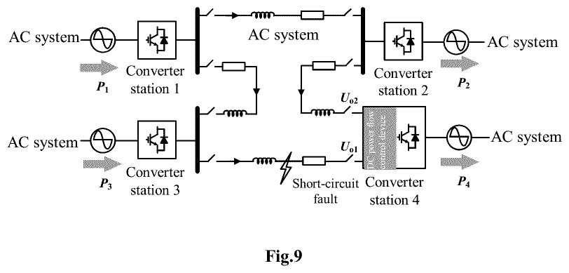

The multi-port DCPFC in Embodiment 2 is connected to two lines, as shown in FIG. 9. The control strategy during steady-state operation remains consistent with Embodiment 1, as illustrated in FIG. 7. The difference is that Embodiment 2 incorporates a current suppression strategy for DC short-circuit faults.

In the simulation, it is assumed that a bipolar short circuit occurs at DC port 1 of the multi-port DCPFC, as shown in FIG. 9.

### Condition 1 (Fault Protection of the DCPFC):

1.5 ms after the fault occurs, fault location is completed, and the submodules of the DCPFC are bypassed to prevent fault currents from entering submodule capacitors, thus achieving fault protection.

### Condition 2 (Active Fault Current Suppression):

1.5 ms after the fault occurs, the active current limiting strategy is executed, that is, to position the bipolar submodule in the forward position to create a reverse voltage, mitigating the surge of fault currents and facilitating system fault ride-through.

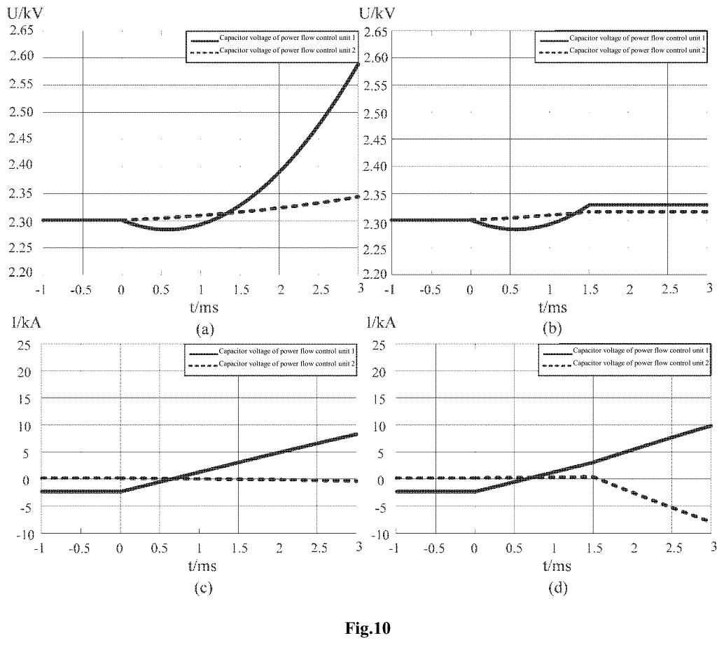

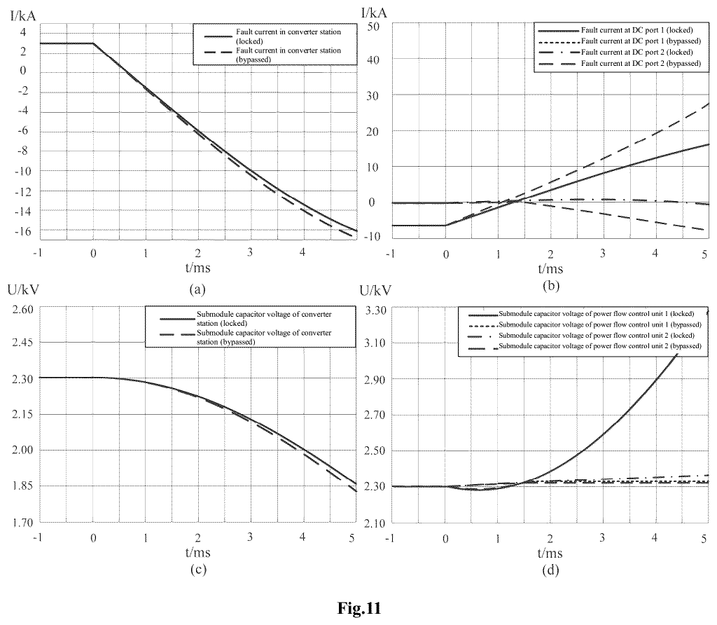

FIGS. 10 and 11 present the simulation results for Condition 1 and Condition 2. FIG. 10 comprises four waveform graphs. Shown from left to right and top to bottom are: submodule capacitor voltages of two DC power flow control units with and without the fault protection strategy, and submodule switching device currents of two DC power flow control units with and without the fault protection strategy. FIG. 11 comprises four waveform graphs. Shown from left to right and top to bottom are: a comparison waveform graph of fault currents before and after adding the fault current limiting strategy to the MMC, a comparison waveform graph of fault currents at two ports before and after adding the fault current limiting strategy to the multi-port DCPFC, a comparison waveform graph of submodule capacitor voltages before and after adding the fault current limiting strategy to the MMC, and a comparison waveform graph of submodule capacitor voltages before and after adding the fault current limiting strategy to the multi-port DCPFC.

The simulation waveform results indicate that the fault protection strategy of the embedded multi-port DCPFC can effectively prevent fault currents from entering the submodule capacitors, thus avoiding overvoltage in the submodule capacitors. The protection method for the embedded multi-port DCPFC under DC short-circuit faults can effectively suppress the fault currents of the DCPFC, while also providing a certain level of suppression for the fault currents of the MMC.

It is important to note that the configuration and arrangement of the present application shown in various exemplary embodiments are merely exemplary. Although only a few embodiments have been described in detail in this disclosure, those who refer to this disclosure will easily understand that many modifications are possible (for example, changes in the dimensions, scales, structures, shapes and proportions of various elements, as well as parameter values (e.g., temperature, pressure, etc.), installation arrangement, use of materials, color and orientation) without materially departing from the novel teachings and advantages of the subject matter described in this application. For example, an element shown as being integrally formed may be composed of multiple parts or elements, the position of the elements may be inverted or otherwise changed, and the nature or number or position of discrete elements may be modified or changed. Therefore, all such modifications are intended to be included within the scope of the present disclosure. The order or sequence of any process or method steps may be changed or reordered according to alternative embodiments. In the claims, any “means-plus-function” clause is intended to cover the structure described herein that performs the stated function, not just structural equivalents but also equivalent structures. Other substitutions, modifications, changes and omissions may be made in the design, operating conditions and arrangement of the exemplary embodiments without departing from the scope of the present disclosure. Therefore, the present disclosure is not limited to specific embodiments, but extends to various modifications that still fall within the scope of the appended claims.

Additionally, to provide a concise description of the exemplary embodiments, not all features of the actual embodiments may be described (i.e., those features that are not relevant to the best mode of carrying out the disclosure currently under consideration or those features that are not related to the implementation of the disclosure).

It should be understood that during the development of any actual embodiment, as in any engineering or design project, a multitude of specific implementation decisions may be made. Such development efforts can be complex and time-consuming; however, for those skilled in the art benefiting from this disclosure, it is expected that such development efforts will involve routine work in design, manufacturing, and production without requiring excessive experimentation.

It should be noted that the above embodiments are provided to illustrate the technical scheme of the present disclosure and are not intended to limit them. Although the present disclosure has been described in detail with reference to preferred embodiments, those skilled in the art should understand that modifications or equivalent substitutions can be made to the technical scheme of the present disclosure without departing from the spirit and scope of the technical scheme of the disclosure, all of which should be included within the scope of the claims of the present disclosure.

It should be noted that the above embodiments are provided to illustrate the technical scheme of the present disclosure and are not intended to limit them. Although the present disclosure has been described in detail with reference to preferred embodiments, those skilled in the art should understand that modifications or equivalent substitutions can be made to the technical scheme of the present disclosure without departing from the spirit and scope of the technical scheme of the disclosure, all of which should be included within the scope of the claims of the present disclosure.

It should be understood by those skilled in the art that the embodiments of the application can be provided as methods, systems, or computer program products. Therefore, the application may take the form of an entirely hardware embodiment, an entirely software embodiment, or an embodiment combining software and hardware aspects. Furthermore, the application may take the form of a computer program product implemented on one or more computer usable storage media (including but not limited to magnetic disk memory, CD-ROM, optical memory, etc.) having computer usable program code embodied therein. The schemes in the embodiments of the application can be implemented in various computer languages, such as object-oriented programming language Java and interpreted scripting language JavaScript.

The application is described with reference to flowcharts and/or block diagrams of methods, equipment (systems), and computer program products according to the embodiments of the application. It should be understood that each flow and/or block in the flowchart and/or block diagram, and combinations of flows and/or blocks in the flowchart and/or block diagram can be implemented by computer program instructions. These computer program instructions may be provided to a processor of a general purpose computer, special purpose computer, embedded processor, or other programmable data processing equipment to produce a machine, such that the instructions executed by the processor of the computer or other programmable data processing equipment produce a device for implementing the functions specified in one or more flows in the flowcharts and/or one or more blocks in the block diagrams.

These computer program instructions may also be stored in a computer-readable memory which can direct a computer or other programmable data processing apparatus to function in a particular manner, such that the instructions stored in the computer-readable memory produce an article of manufacture including an instruction device which implements the functions specified in one or more flows in the flowcharts and/or one or more blocks in the block diagrams.

These computer program instructions may also be loaded onto a computer or other programmable data processing apparatus such that a series of operational steps are performed on the computer or other programmable apparatus to produce a computer implemented process, such that the instructions executed on the computer or other programmable apparatus provide steps for implementing the functions specified in one or more flows in the flowcharts/or one or more blocks in the block diagrams.

Although the preferred embodiments of the application have been described, those skilled in the art can make additional changes and modifications to these embodiments once they know the basic inventive concepts. Therefore, the appended claims are intended to be interpreted as including the preferred embodiment and all changes and modifications that fall within the scope of the application.

Obviously, various modifications and variations can be made to this application by those skilled in the art without departing from the spirit and scope of this application. Thus, the application is also intended to comprise such modifications and variations if they fall within the scope of the claims of the application and their equivalents.

What is claimed is:

1. A flexible direct current (DC) converter featuring multi-port DC power flow control, comprising:
a modular multilevel converter (MMC); and
a DC power flow controller (DCPFC) embedded within the MMC.

2. The flexible DC converter according to claim 1, wherein the DCPFC comprises two or more DC power flow control units, a number of the DC power flow control units is equal to a number of ports of the DCPFC, and each DC power flow control unit is capable of adjusting a DC power flow on a connected DC line.

3. The flexible DC converter according to claim 2, wherein each of the DC power flow control units consists of a three-phase star-connected submodule chain and an arm inductor, and a three-phase neutral point resulting from a connection of the submodule chain and the inductor serves as a DC power flow regulation port.

4. The flexible DC converter according to claim 3, wherein the MMC is a medium- or high-voltage, three-phase voltage source converter with a modular multilevel structure, capable of alternating current (AC)-DC power conversion, facilitating interconnection of medium- and high-voltage AC power grids with DC systems.

5. The flexible DC converter according to claim 4, wherein the embedded DCPFC is symmetrically installed on both upper and lower arms of the MMC, or installed on either an upper arm or a lower arm of the MMC.

6. The flexible DC converter according to claim 5, wherein the submodule chain is a unipolar submodule chain, a bipolar submodule chain, or a hybrid submodule chain comprising both unipolar and bipolar submodules.

7. A control method of the embedded DCPFC according to claim 1, comprising DC power flow control loops on multiple lines, energy balance control loops between the MMC and the DCPFC, and internal energy balance control loops within the DCPFC, wherein
when the embedded DCPFC connects two or more DC lines, a sum of power on all output lines equals a total power of the MMC; when the embedded DCPFC connects a total of N DC output lines, active control is performed on the power flow of N−1 lines, while DC power flow on the remaining line equals the total power flow minus a sum of the power flow on the N−1 lines.

8. The control method according to claim 7, wherein for the DC power flow control loops on multiple lines,
a line power flow control loop calculates a difference between voltage reference values of other lines and a reference circuit voltage to determine DC components of voltages of each DC power flow control unit, and mathematical equations are as follows:
$$\{ \begin{matrix}{U}_{p 1 a , d c} = {U}_{o 1} - {U}_{d} \\ ⋮ \\ {U}_{p k a , d c} = {U}_{ok} - {U}_{d} \\ ⋮ \\ {U}_{pNa , d c} = {U}_{oN} - {U}_{d}\end{matrix}$$
wherein U_{d} is a rated voltage of a DC system, which is also equal to a reference line voltage; Uₚ₁ₐ, Uₚₖₐ and U_{pNa} are the DC components of the voltages of the DC power flow control units connected to the first line, the k^{th} line, and the N^{th} line respectively; and Uₒₗ, Uₒₖ and U_{oN} are DC voltage reference values of the first line, the k^{th} line, and the N^{th} line respectively.

9. The control method according to claim 8, wherein for the energy balance control loops between the MMC and the DCPFC,
by superimposing energy balancing control voltages on arms of the DC flow power control units and arms of the modular multilevel converter, AC coupled energy is formed to compensate for accumulated DC energy, and mathematical equations for the overall input and output energy of the DCPFC are as follows:
$$\{ \begin{matrix}{P}_{DCPFC \_ out} = {\sum }_{i = 1}^{N} ( {U}_{pia , d c} - \frac{1}{N} {\sum }_{l = 1}^{N} {U}_{pla , d c} ) {I}_{o i} \\ {P}_{DCPFC \_ In} = {\sum }_{j = a , b , c} {i}_{jp , a c} ( \frac{1}{N} {\sum }_{i = 1}^{N} {U}_{pij , a c} ) + ( \frac{1}{N} {\sum }_{i = 1}^{N} {U}_{pia , d c} ) {I}_{d}\end{matrix}$$
wherein P_{DCPFC_out} is the total output energy of the multi-port DCPFC, P_{DCPFC_in} is the total input energy of the multi-port DCPFC, U_{pia,dc} and U_{pia,ac} are DC and AC components of a voltage of the DC power flow control unit connected to the i^{th} line respectively, Iₒᵢ is a DC current of the i^{th} line, I_{d} is the sum of DC currents of all lines, and i_{jp,ac} is an AC component of an upper arm current in phase j of the MMC.

10. The control method according to claim 9, wherein for the internal energy balance control loops within the DCPFC,
a mathematical equation for the energy relationship within the DCPFC is as follows:
$$\frac{Δ {p}_{1}}{3} + \underline{Δ {p}_{c 1 a}} = … = \frac{Δ {p}_{k}}{3} + \underline{Δ {p}_{cka}} = … = \frac{Δ {p}_{N}}{3} + \underline{Δ {p}_{cNa}} , {\sum }_{i = 1}^{N} \underline{Δ {p}_{cia}} = 0$$
wherein Δp₁, Δpₖ and Δp_{N} are DC energy of the first, k^{th} and N^{th} DC power flow control units respectively, and Δp_{c1a}, Δp_{cka} and Δp_{cNa} are AC coupled energy of the first, k^{th} and N^{th} DC power flow control units respectively.

11. A main circuit parameter designing method for the embedded DCPFC according to claim 1, comprising design of a number of submodules of the DC power flow control unit and a number of the MMC, design of capacitance of the submodules of the DC power flow control unit and the MMC, design of arm inductance of the DCPFC, and design of power devices of the submodules of the DC power flow control unit and the MMC.

12. The main circuit parameter designing method according to claim 11, wherein the DCPFC is installed asymmetrically, embedded at an end of an upper arm of the MMC; and
the DCPFC uses bipolar full-bridge submodules, and the MMC employs unipolar half-bridge submodules.

13. The main circuit parameter designing method according to claim 12, wherein for the design of the number of submodules of the DC power flow control unit and the MMC,
a mathematical equation for selecting the number of submodules of the DCPFC is as follows:
$${N}_{PFC} \geq \frac{ε {U}_{d}}{2 {U}_{CPFC}} + \frac{1}{{U}_{CPFC}} \sqrt{{( 2 ε E \frac{Δ {P}_{1 , 2} cos ( φ - δ )}{P} )}^{2} + {( \frac{ω {L}_{PFC}}{6 E} \cdot \frac{P}{Δ {P}_{1 , 2} cos ( φ - δ )} )}^{2}} \geq \frac{ε {U}_{d}}{2 {U}_{CPFC}}$$
wherein N_{PFC} is the number of submodules in a submodule chain in the DCPFC, U_{CPFC} is a rated voltage of the submodules in the DCPFC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
mathematical equations for selecting the number of submodules of the MMC are as follows:
$$\{ \begin{matrix}{N}_{MMC \_ p} \geq [ \frac{1}{2} - \frac{ε Δ {P}_{1 , 2}}{4 P} ] \frac{{U}_{d}}{{U}_{C}} + \frac{1}{{U}_{C}} \sqrt{{E}^{2} + {[ ε \frac{Δ {P}_{1 , 2} E cos ( φ - δ )}{P} ]}^{2} + {( \frac{ω {L}_{PFC} P}{12 E cos ( φ - δ )} )}^{2}} \\ {N}_{MMC \_ n} \geq [ \frac{1}{2} + \frac{ε Δ {P}_{1 , 2}}{4 P} ] \frac{{U}_{d}}{{U}_{C}} + \frac{1}{{U}_{C}} \sqrt{{E}^{2} + {( \frac{ω {L}_{PFC} P}{12 E cos ( φ - δ )} )}^{2}}\end{matrix}$$
wherein N_{MMC,p} and N_{MMC,n} are the number of submodules of the upper arm and lower arm of the MMC respectively, U_{C} is a rated voltage of the submodules of the MMC, U_{d} is a rated voltage of a DC grid, ε is a ratio of a maximum regulating voltage of the DCPFC to the rated voltage of the DC grid, ΔP_{1,2} is a maximum difference of DC power flow of two DC lines, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

14. The main circuit parameter designing method according to claim 13, wherein for the design of the capacitance of submodules of the DC power flow control unit and the MMC,
mathematical equations for selecting the capacitance value of submodules of the DCPFC are as follows:
$$\{ \begin{matrix}{C}_{PFC} \geq \frac{1}{{r}_{1}} \cdot \frac{1}{{N}_{PFC} {U}_{CPFC}} \sqrt{{{ε}^{2} [ \frac{1.6}{11 ω cos ( φ - δ )} + \frac{2 P cos ( φ - δ )}{11 ω} ]}^{2} + {[ \frac{{L}_{PFC} {P}^{2}}{16 {E}^{2}} ]}^{2}} \\ {C}_{PFC} \geq \frac{1}{{r}_{2}} \cdot \frac{1}{{N}_{PFC} {U}_{CPFC}} \sqrt{{[ \frac{{L}_{PFC} {P}^{2} [ 2 cos ( φ - δ ) - 1.8 ]}{259 {E}^{2} cos ( φ - δ )} ]}^{2} + {{ε}^{2} [ \frac{[ 2 cos ( φ - δ ) - 1.8 ] P}{86 ω} ]}^{2}}\end{matrix}$$
wherein C_{PFC} is the capacitance of the submodules of the DCPFC, N_{PFC} is the number of submodules in a submodule chain in the DCPFC, U_{CPFC} is a rated voltage of the submodules in the DCPFC, r₁ and r₂ are fundamental frequency and double frequency fluctuation rates of a submodule capacitor voltage respectively, ε is a ratio of a maximum regulating voltage of the DCPFC to a rated voltage of a DC grid, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
mathematical equations for selecting the capacitance value of modular multilevel submodules are as follows:
$$\{ \begin{matrix}{C}_{0} \geq \frac{1}{{ε}_{1}} \cdot \vert \frac{3 P}{10 ω {N}_{MMC}^{2} {U}_{C}^{2} cos ( φ - δ )} \vert \\ {C}_{0} \geq \frac{1}{{ε}_{2}} \cdot \vert \frac{P}{12 ω {N}_{MMC}^{2} {U}_{C}^{2} cos ( φ - δ )} \vert\end{matrix}$$
wherein C₀ is the capacitance of the submodules of the MMC, N_{MMC} is the number of submodules in one arm of the MMC, U_{C} is a rated voltage of submodule capacitors of the MMC, ε₁ and ε₂ are fundamental frequency and double frequency fluctuation rates of a submodule capacitor voltage of the MMC respectively, P is the total power of the MMC, φ is a phase angle of an AC current of the MMC, and δ is a phase angle difference between a fundamental AC component of an arm voltage of the MMC and a grid voltage.

15. The main circuit parameter designing method according to claim 14, wherein for the design of the arm inductance of the DCPFC,
mathematical equations for selecting the arm inductance of the DCPFC are as follows:
$$AC negative sequence current constraint :$$
$${L}_{PFC} \geq \frac{2}{{ω}_{0}} sin ( 2 arc sin ( \frac{1.5 \%}{η} ) ) - 4 {L}_{T} - 2 {L}_{0}$$
$$Internal energy balance constraint for DC power flow control device :$$
$${L}_{PFC} \leq \frac{3 {N}_{PFC} {U}_{CPFC}}{4 {I}_{d} {ω}_{0}}$$
$$Short - circuit fault current suppression limit :$$
$${L}_{PFC} \geq \frac{( 2 + ε ) {U}_{d}}{λ} - 12 {L}_{d c} - 4 {L}_{0}$$
$$Resonant frequency limit for phase unit :$$
$${ω}_{res} = \sqrt{\frac{{N}_{MMC}^{2} + {N}_{PFC}^{2}}{( 4 {L}_{0} + {L}_{PFC} ) ( {N}_{MMC} + {N}_{PFC} ) {C}_{0}}} \approx {ω}_{0}$$
wherein L_{PFC} is the arm inductance of the DCPFC, ω₀ is angular frequency at the fundamental frequency, ωᵣₑₛ is resonant angular frequency of the series resonance formed between the submodule chain and arm inductance within a phase unit of an integrated system of the DCPFC and the MMC, L_{T} is an inductance value of a connected transformer, L₀ is an arm inductance value of the MMC, L_{dc} is an inductance value of a smoothing reactor of a DC system, N_{PFC} is the number of submodules in a submodule chain of the DCPFC, U_{CPFC} is a rated voltage of submodules in the DCPFC, U_{d} is a rated voltage of a DC grid, I_{d} is a rated current of the DC grid, ε is a ratio of a maximum regulating voltage of the DCPFC to the rated voltage of the DC grid, λ is an upper limit of a transient current change rate under short-circuit faults, η is a per-unit value of a negative sequence current amplitude, C₀ is the capacitance of submodules of the MMC, and N_{MMC} is the number of submodules in one arm of the MMC.

16. The main circuit parameter designing method according to claim 15, wherein for the design of power devices of submodules of the DC power flow control unit and the MMC,
mathematical equation for calculating voltage and current stresses of the power devices of the DC power flow control unit are as follows:
$$\{ \begin{matrix}\begin{matrix}{A}_{PFC \_ U} = \frac{ε {U}_{d}}{4 {N}_{PFC}} + \\ \frac{1}{2 {U}_{d} {N}_{PFC}} \sqrt{{( \frac{Δ {P}_{1 , 2} E cos ( φ - δ )}{P} )}^{2} + {( \frac{ω {L}_{PFC} P}{3} )}^{2}}\end{matrix} \\ \begin{matrix}{A}_{PFC \_ Ures} = \frac{ε {U}_{d}}{4 {N}_{PFcC}} + \\ \frac{1}{4 {U}_{d} {N}_{PFC}} \sqrt{2 {( \frac{Δ {P}_{1 , 2} E cos ( φ - δ )}{P} )}^{2} + 2 {( \frac{ω {L}_{PFC} P}{3} )}^{2}}\end{matrix}\end{matrix}$$
$$\{ \begin{matrix}{A}_{PFC \_ I} = \frac{max \{ {P}_{1} , {P}_{2} \}}{3 {U}_{d}} + P \sqrt{{( \frac{1}{6 E cos ( φ - δ )} )}^{2} + {( \frac{1}{3 {U}_{d}} )}^{2}} \\ {A}_{PFC \_ Ires} = \frac{max \{ {P}_{1} , {P}_{2} \}}{3 {U}_{d}} + \frac{P \sqrt{2 {( \frac{1}{6 E cos ( φ - δ )} )}^{2} + 2 {( \frac{1}{3 {U}_{d}} )}^{2}}}{2}\end{matrix}$$
wherein A_{PFC_U} and A_{PFC_Ures} are peak and effective values of a maximum voltage withstood by a single power electronic device in an arm submodule of the DCPFC respectively, A_{PFC_I} and A_{PFC_Ires} are peak and effective values of a maximum current withstood by a single power electronic device in the arm submodule of the DCPFC respectively, P₁ and P₂ are the DC power flow of two DC lines, ΔP_{1,2} is a maximum difference between the DC power flow of the two DC lines, ε is a ratio of a maximum regulating voltage of the DCPFC to a rated voltage of a DC grid, U_{d} is the rated voltage of the DC grid, N_{PFC} is the number of submodules in a submodule chain of the DCPFC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC; and
mathematical equations for calculating the voltage and current stresses of the power devices of the MMC are as follows:
$$\{ \begin{matrix}{A}_{{MMC}_{U}} = \frac{1}{2 {N}_{MMC}} \{ [ \frac{1}{2} + \frac{Δ {P}_{1 , 2}}{2 {EU}_{d} cos ( φ - δ )} ] {U}_{d} + \sqrt{{E}^{2} + {( \frac{Δ {P}_{1 , 2} E cos ( φ - δ )}{{PU}_{d}} )}^{2} + {( \frac{ω {L}_{PFC} P}{12 E cos ( φ - δ )} )}^{2}} \} \\ {A}_{MMC \_ Ures} = \frac{1}{2 {N}_{MMC}} \{ \frac{1}{2} ( [ \frac{1}{2} + \frac{Δ {P}_{1 , 2}}{2 {EU}_{d} cos ( φ - δ )} ] {U}_{d} + \sqrt{{E}^{2} + 2 {( \frac{Δ {P}_{1 , 2} E cos ( φ - δ )}{{PU}_{d}} )}^{2} + 2 {( \frac{ω {L}_{PFC} P}{12 E cos ( φ - δ )} )}^{2}} ) \}\end{matrix}$$
$$\{ \begin{matrix}{A}_{MMC \_ I} = \frac{P}{3 {U}_{d}} + \frac{P}{3 E cos ( φ - δ )} \\ {A}_{MMC \_ Ires} = \frac{P}{3 {U}_{d}} + \frac{\sqrt{2} P}{6 E cos ( φ - δ )}\end{matrix}$$
wherein A_{MMC_U} and A_{MMC_Ures} are peak and effective values of a maximum voltage withstood by a single power electronic device in an arm submodule of the MMC respectively, A_{MMC_I} and A_{MMC_Ires} are peak and effective values of a maximum current withstood by a single power electronic device in the arm submodule of the MMC respectively, ΔP_{1,2} is a maximum difference between the DC power flow of two DC lines, U_{d} is a rated voltage of a DC grid, N_{MMC} is the number of submodules in one arm of the MMC, P is the total power of the MMC, φ is a phase angle of an AC current of the MMC, δ is a phase angle difference between a fundamental AC component of an arm voltage of the MMC and a grid voltage, E is an amplitude of the fundamental AC component of the arm voltage of the MMC, ω is angular frequency, and L_{PFC} is the arm inductance of the DCPFC.

17. A protection method for the embedded DCPFC according to claim 1 under DC short-circuit faults, comprising protection of the DCPFC under DC short-circuit faults, and active restriction of fault currents under DC short-circuit faults.

18. The protection method according to claim 17, wherein the protection of the DCPFC under DC short-circuit faults comprises:
controlling the submodules within the DCPFC to operate in a specific switching state, or installing a protection device on the submodules within the DCPFC;
wherein the specific switching state of the submodule refers to a condition where a submodule capacitor is bypassed and currents flow solely through a switching device, and the protection device consists of a load shedding circuit or a thyristor bypass switch; and
the switching device of the submodule withstands fault currents, and by operating the submodule in the specific switching state, the fault currents are prevented from flowing into the submodule capacitor, thus achieving fault protection.

19. The protection method according to claim 18, wherein the protection device is a load shedding circuit connected in parallel with the submodule capacitor, and
the load shedding circuit is formed by a combination of diodes, resistors, and switching devices in series and parallel, which dissipates the energy of the fault currents to prevent overvoltage across the submodule capacitor, thereby achieving fault protection.

20. The protection method according to claim 19, wherein the protection device is a distributed or centralized thyristor bypass switch, the thyristor bypass switch consists of anti-parallel thyristors, a resistor-capacitor circuit, and static resistors connected in parallel, the distributed thyristor bypass switches are installed within each submodule, and the centralized thyristor bypass switches are connected in parallel with the submodule chains; and the submodules are bypassed through the fast action of the bidirectional thyristors, preventing the fault currents from flowing through the submodules, thus achieving fault protection.

21. The protection method according to claim 17, wherein the active restriction of fault currents under DC short-circuit faults comprises:
controlling the submodules within the DCPFC to operate in a specific switching state, or installing a protection device on the submodules within the DCPFC;
wherein the specific switching state of the submodule refers to a condition where the submodule is locked or positively engaged, the protection device consists of a load shedding circuit and a fault current limiter, the load shedding circuit is formed by a combination of diodes, resistors, and switching devices arranged in series and parallel, and the fault current limiter is formed by a combination of resistors, inductors, and surge arresters arranged in series and parallel; and
the submodule capacitor withstands a certain fault voltage, the switching device of the submodule endures the fault currents, and by operating the submodule in a specific switching state, the submodule is integrated into the circuit with a negative voltage, effectively suppressing the fault currents.

22. The protection method according to claim 21, wherein the protection device is a load shedding circuit connected in parallel with the submodule capacitor, enabling active suppression of step-down fault currents; the protection device is a distributed or centralized fault current limiter, which is composed of thyristor bypass switches, resistors, inductors, and surge arresters connected in series, the distributed fault current limiters are installed within each submodule, and the centralized fault current limiters are connected in parallel with the submodule chains; and by means of the fault current limiter, the rise of fault currents is restricted, assisting a DC grid in suppressing and clearing faults.
